(19) United States
(12) Patent Application Publication
(10) Pub. No.: US 2009/0090109 A1
(43) Pub. Date: Apr. 9, 2009

(54) GRANULAR THERMAL ENERGY STORAGE MEDIUMS AND DEVICES FOR THERMAL ENERGY STORAGE SYSTEMS

(76) Inventors: David R. MILLS, Palo Alto, CA (US); Robert C. MIERISCH, Palo Alto, CA (US)

Correspondence Address: MORRISON & FOERSTER LLP, 755 PAGE MILL RD, PALO ALTO, CA, 94304-1018, US

(21) Appl. No.: 12/135,124

(22) Filed: Jun. 6, 2008

Related U.S. Application Data
(60) Provisional application No. 60/933,648, filed on Jun. 6, 2007.
(60) Provisional application No. 60/933,615, filed on Jun. 6, 2007.
(60) Provisional application No. 60/933,637, filed on Jun. 6, 2007.

(51) Int. Cl. F01K 3/00; F28F 7/00; F03B 11/00

(52) U.S. Cl. 60/659; 165/185; 137/561 R

(57) ABSTRACT

The invention provides compositions for use in thermal energy storage systems, including thermal energy storage mediums, fluid channeling devices and thermally conductive heat transfer elements, and methods for storing thermal energy. A thermal energy storage system is provided, comprising: (a) a granular thermal energy storage medium comprising at least a first size class and a second size class; wherein the individual granules of each size class deviate from the average granular size for that size class by no more than about ±50%; wherein first size class is the largest size class; wherein the ratio of the average size of the first size class to the average size of the second size class is at least about 2:1; and (b) one or more conduits disposed within the medium, and arranged to receive a source of thermal energy.

### CROSS-REFERENCE TO RELATED APPLICATIONS

This application claims the benefit under 35 U.S.C. § 119(e) of U.S. Provisional Applications Ser. Nos. 60/933,648, 60/933,615 and 60/933,637 all three filed Jun. 6, 2007, the contents of which are incorporated herein by reference in their entirety.

### BACKGROUND OF THE INVENTION

Thermal energy storage systems are, in various circumstances, required to be incorporated in thermal power plants, including those that employ nuclear reactors, package boilers and solar energy collector systems. The thermal energy storage systems may be required as buffers against transient demands that exceed the steady state output capacities of plants, against temporary reduction in input heat or, alternatively, to provide long term thermal energy storage when heat generating capabilities cannot, for various reasons, be synchronized with load demands. One or the other or all of these requirements may exist in relation to thermal power plants, including those incorporating solar energy collector systems for use in generating thermal energy.

Solar energy collector systems may comprise a Compact Linear Fresnel Collector (CLFR) system employing a field of reflectors and elevated receivers that are illuminated by reflected radiation for energy exchange with fluid that is carried through the receivers. A CLFR system is typically employed in the heating of a working fluid for delivery to electrical generating plant, either for admission directly to a turbine or for heat exchange with fluid that is expanded through the turbine. A reflector that has been developed for use in a CLFR system is disclosed in International Patent Applications numbered PCT/AU2004/000883 and PCT/AU2004/000884, both dated 1 Jul. 2004, and a receiver for such system is disclosed in International Patent Application number PCT/AU2005/000208, dated 17 Feb. 2005.

Solar energy collector systems function only when adequate incident solar radiation is present and, in order to prolong the duty cycle of solar-based power generation, to accommodate transient reductions of solar radiation or to provide a buffer against transient loads, thermal energy produced in excess of demand during periods of high-level solar radiation and/or low power consumption must be stored. Water/steam reticulating storage systems have previously been considered for this purpose, one involving the use of pre-existing or purpose-built deep subterranean cavities, another involving the employment of above-ground pressure vessels, a third involving the use of concrete-encased fluid feed pipes, a fourth involving the use of cylindrical steel vessels within vertically extending subterranean cavities, and a fifth involving the use of sand-encased fluid feed pipes.

The first type of storage currently is employed for combustible gases, for example LPG, but for high temperature water storage it would be necessary to completely line the cavity to provide an impermeable water-rock interface, and the cavity would need to be located at a depth to provide for a rock surface stratum of thickness sufficient to withstand the high fluid pressure within the cavity. These requirements impose formidable construction and cost constraints.

Above ground pressure vessels that are suitable for containing a working fluid such as water at required temperature and pressure sufficient to maintain the fluid in a liquid phase have been built for various purposes and are commonly referred to as “steam accumulators”. However, the fabrication and material costs inherent in building a vessel having the volumetric capacity required for storage of sufficient working fluid to provide for sustained fluid mass flow rates has been determined to be disproportionately high relative to other components of a total power generating system.

In the third type of storage, cracks occur in the concrete encasement due to differential expansion between the concrete and the pipes. This leads to the appearance of gaps between the pipes and the concrete and, consequently, poor heat transfer (in both directions) between the pipes and the concrete due to increased thermal resistance. Cracks in the concrete also cause thermal islands which cannot usefully participate in thermal energy storage.

The fourth type of storage is disclosed in Australian Provisional Patent Applications numbered 2006903801 and 2006905367, dated 14 Jul. 2006 and 28 Sep. 2006 respectively.

The fifth type of storage was rejected in the 1980s, due to low thermal conductivity, as the number of interfaces between the grains of sand reduce thermal conductivity, and higher costs, as more closely spaced pipes were required.

There is a need for thermal energy storage systems that provide sufficient effective storage capacity for use in a thermal power plant, and which further are cost-effective. There is a further need for thermal energy storage systems that deliver a reduced impact on the environment, including reduced greenhouse gas output from the transport, construction, installation and operation of the storage system.

All patents, patent applications, documents, and articles cited herein are herein incorporated by reference in their entirety.

### BRIEF SUMMARY OF THE INVENTION

In one aspect of the invention is a thermal energy storage system comprising: (a) a granular thermal energy storage medium comprising at least a first size class of granules and a second size class of granules; wherein each size class of granules comprises one or more components; wherein the individual granules of each size class deviate from the average granular size for that size class by no more than about ±50%; wherein first size class is the largest size class; wherein the ratio of the average size of the first size class to the average size of the second size class is at least about 2:1; and (b) one or more conduits disposed within the medium, and arranged to receive a source of thermal energy. In some embodiments, each component comprises a material individually selected from the group consisting of: aggregate, glass, sand, and silt. In some embodiments, the aggregate is rock or gravel. In some embodiments, the rock is crushed rock. In some embodiments, the rock is monolithic rock. In some embodiments, the rock is quartzite. In some embodiments, the gravel is medium gravel. In some embodiments, the gravel is fine gravel. In some embodiments, the sand is coarse sand. In some embodiments, the sand is fine sand. In some embodiments, the sand is very fine sand. In some embodiments, the ratio of the average size of the first size class to the average size of the second size class is at least about 3:1. In some embodiments, the ratio of the average size of the first size class to the average size of the second size class is at least about 4:1. In some embodiments, the average size of the first size class is about 50 mm or less. In some embodiments, the average size of the first size class is about 16 mm to about 40 mm. In some embodiments, the average size of the first size class is about 20 mm to about 40 mm. In some embodiments, the average size of the first size class is about 10 mm to about 40 mm. In some embodiments, the average size of the first size class is about 10 mm to about 20 mm. In some embodiments, the components of the first size class each comprise a material independently selected from the group consisting of rock and gravel. In some embodiments, the average size of the second size class is about 4 mm to about 12 mm. In some embodiments, the average size of the second size class is about 0.060 mm to about 2 mm. In some embodiments, the average size of the second size class is about 2 mm to about 4 mm. In some embodiments, the average size of the second size class is about 1 mm to about 3 mm. In some embodiments, the components of the second size class each comprise a material independently selected from the group consisting of rock and gravel. In some embodiments, the thermal energy storage medium comprises a third size class. In some embodiments, the ratio of the average size of the second size class to the average size of the third size class is at least about 2:1. In some embodiments, the components of the third size class each comprise a material independently selected from the group consisting of rock, gravel, glass, sand, and silt. In some embodiments, the average size of the third size class is about 1 mm to about 3 mm. In some embodiments, the average size of the third size class is about 0.7 mm to about 2 mm. In some embodiments, the average size of the third size class is about 0.1 to about 0.4 mm. In some embodiments, the average size of the third size class is about 0.250 mm. In some embodiments, the thermal energy storage medium comprises a fourth size class. In some embodiments, the ratio of the average size of the third size class to the average size of the fourth size class is at least about 2:1. In some embodiments, the average size of the fourth size class is about 0.3 mm to about 0.8 mm. In some embodiments, the average size of the fourth size class is about 0.2 mm to about 0.6 mm. In some embodiments, the average size of the fourth size class is about 0.01 mm to about 0.05 mm. In some embodiments, the average size of the fourth size class is about 0.032 mm. In some embodiments, the thermal energy storage medium comprises a fifth size class. In some embodiments, the ratio of the average size of the fourth size class to the average size of the fifth size class is at least about 2:1. In some embodiments, the average size of the fifth size class is about 0.05 mm to about 0.15 mm. In some embodiments, the average size of the fifth size class is about 0.04 mm to about 0.12 mm. In some embodiments, the average size of the fifth size class is about 0.025 mm to about 0.15 mm. In some embodiments, the average size of the fifth size class is about 0.004 mm. In some embodiments, the thermal energy storage system comprises up to 5 size classes, wherein the ratio of the average size of each successively smaller size class to the average size of the preceding size class is no more than about 1:2. In some embodiments, the thermal energy storage medium comprises one or more soluble minerals. In some embodiments, the soluble mineral is a carbonate, an oxide, or a nitrate. In some embodiments, the soluble mineral is Na₂CO₃. In some embodiments, the soluble mineral is NaNO₃. In some embodiments, the soluble mineral is NaNO₂. In some embodiments, the thermal energy storage medium comprises two or more soluble minerals. In some embodiments, the thermal energy storage medium comprises silicone. In some embodiments, the thermal energy storage medium comprises mineral oil. In some embodiments, the first size class comprises about 20% to about 70% by volume of the total medium. In some embodiments, the first size class comprises about 35% to about 65% by volume of the total medium. In some embodiments, the first size class comprises about 45% to about 60% by volume of the total medium. In some embodiments, the first size class comprises at least about 20% by volume of the total medium. In some embodiments, the first size class comprises at least about 35% by volume of the total medium. In some embodiments, the first size class comprises at least about 45% by volume of the total medium. In some embodiments, the second size class comprises about 1% to about 80% by volume of the total thermal energy storage medium. In some embodiments, the second size class comprises about 2% to about 30% by volume of the total medium. In some embodiments, the second size class comprises about 1% to about 30% by volume of the total thermal energy storage medium. In some embodiments, the second size class comprises about 10% to about 15% by volume of the total medium. In some embodiments, the second size class comprises at least about 1% by volume of the total medium. In some embodiments, the second size class comprises at least about 2% by volume of the total medium. In some embodiments, the second size class comprises at least about 10% by volume of the total medium. In some embodiments, the third size class, when present, comprises about 1% to about 20% by volume of the total medium. In some embodiments, the third size class, when present, comprises about 5% to about 25% by volume of the total medium. In some embodiments, the third size class, when present, comprises about 5% to about 15% by volume of the total medium. In some embodiments, the third size class, when present, comprises about 5% to about 10% by volume of the total medium. In some embodiments, the third size class, when present, comprises at least about 1% by volume of the total medium. In some embodiments, the third size class, when present, comprises at least about 5% by volume of the total medium. In some embodiments, the third size class, when present, comprises at least about 7% by volume of the total medium. In some embodiments, the fourth size class, when present, comprises about 2% to about 60% by volume of the total thermal energy storage medium. In some embodiments, the fourth size class, when present, comprises about 1% to about 10% by volume of the total medium. In some embodiments, the fourth size class, when present, comprises about 1% to about 5% by volume of the total medium. In some embodiments, the fourth size class, when present, comprises about 1% to about 3% by volume of the total medium. In some embodiments, the fourth size class, when present, comprises at least about 2% by volume of the total medium. In some embodiments, the fourth size class, when present, comprises at least about 4% by volume of the total medium. In some embodiments, the fourth size class, when present, comprises at least about 10% by volume of the total medium. In some embodiments, the one or more soluble minerals, when present, comprise about 0.1% to about 10% by volume of the total medium. In some embodiments, the fifth size class, when present, comprises about 0.2% to about 2% by volume of the total medium. In some embodiments, the fifth size class, when present, comprises about 0.4% to about 1.5% by volume of the total medium. In some embodiments, the fifth size class, when present, comprises about 0.6% to about 1.4% by volume of the total medium. In some embodiments, the one or more soluble minerals, when present, comprise about 0.1% to about 5% by volume of the total medium. In some embodiments, the one or more soluble minerals comprise about 0.1% to about 1% by volume of the total medium. In some embodiments, the one or more soluble minerals comprise about 0.2% to about 0.7% by volume of the total medium. In some embodiments, the one or more soluble minerals comprise at least about 0.2% by volume of the total medium. In some embodiments, the one or more soluble minerals comprise at least about 0.4% by volume of the total medium. In some embodiments, the one or more soluble minerals comprise at least about 0.8% by volume of the total medium. In some embodiments, each size class has a thermal conductivity of at least about 0.1 W/m·K at 250° C. In some embodiments, each size class has a thermal conductivity of at least about 0.3 W/m·K at 250° C. In some embodiments, each size class has a thermal conductivity of at least about 0.4 W/m·K at 250° C. In some embodiments, each size class has a thermal conductivity of at least about 0.5 W/m·K at 250° C. In some embodiments, each size class has a thermal conductivity of at least about 0.8 W/m·K at 250° C. In some embodiments, each size class has a thermal conductivity of at least about 1.0 W/m·K at 250° C. In some embodiments, each size class has a thermal conductivity of at least about 2.0 W/m·K at 250° C. In some embodiments, each size class has a thermal conductivity of at least about 3.0 W/m·K at 250° C. In some embodiments, the total density of the thermal energy storage medium is at least about 1000 kg/m³. In some embodiments, the total density of the thermal energy storage medium is at least about 1200 kg/m³. In some embodiments, the total density of the thermal energy storage medium is at least about 1400 kg/m³. In some embodiments, the total density of the medium is at least about 1800 kg/m³. In some embodiments, the total density of the medium is at least about 1900 kg/m³. In some embodiments, the thermal energy storage medium has a void volume fraction of less than about 30%. In some embodiments, the thermal energy storage medium has a void volume fraction of less than about 10%. In some embodiments, the thermal energy storage medium has a void volume fraction of less than about 5%. In some embodiments, the source of thermal energy is generated by a solar energy collector system.

The above described thermal energy storage system, in any of its embodiments as described herein, may be used in a method for utilizing stored thermal energy, comprising: directing a source of thermal energy through the one or more conduits of the thermal energy storage system, whereby thermal energy transfers from the source of thermal energy into the thermal energy storage medium; and extracting thermal energy stored in the thermal energy storage medium at a later point in time. In some embodiments, the source of thermal energy is generated by a solar energy collector system. In some embodiments, the source of thermal energy is steam. In some embodiments, the source of thermal energy is pentane.

The above described thermal energy storage system, in any of its embodiments as described herein, may be used in a thermal power plant comprising: a turbine; a heating system for heating a working fluid to be employed as an energy source for the turbine; and a thermal energy storage system located in circuit between the heating system and the turbine. In some embodiments, the heating system is a solar energy collector system. In some embodiments, the heated working fluid is steam.

The above described thermal energy storage system, in any of its embodiments as described herein, may be used in a steam plant comprising: a heating system for heating water, wherein steam is delivered to a outlet; and a thermal energy storage system located in circuit between the heating system and the outlet. In some embodiments, the heating system is a solar energy collector system.

In another aspect of the invention is a fluid channelling device comprising first and second spaced-apart conduit portions and a plurality of linking conduits extending between and interconnecting the first and second conduit portions in fluid passage communication, wherein at least some of the linking conduits have longitudinally spaced protuberant regions.

In another aspect of the invention is a thermal energy storage system comprising: a thermal energy storage medium, and at least one fluid channelling device comprising first and second spaced-apart conduit portions and a plurality of linking conduits extending between and interconnecting the first and second conduit portions in fluid passage communication, wherein at least some of the linking conduits have longitudinally spaced protuberant regions, wherein the at least one fluid channelling device is disposed within the thermal energy storage medium with the longitudinally spaced protuberant regions in contact with the medium. In some embodiments, the thermal energy storage system comprises an earthen structure composed substantially of conductive inorganic mineral material. In some embodiments, the thermal energy storage medium comprises a granular thermal energy storage medium as described herein.

In another aspect of the invention is a thermal power plant comprising: (a) a turbine; (b) a heating system for heating a working fluid to be employed as an energy source for the turbine, and (c) a thermal energy storage system located in circuit between the heating system and the turbine, wherein the thermal energy storage system comprises: a thermal energy storage medium, and at least one fluid channelling device comprising first and second spaced-apart conduit portions and a plurality of linking conduits extending between and interconnecting the first and second conduit portions in fluid passage communication, wherein at least some of the linking conduits have longitudinally spaced protuberant regions, wherein the at least one fluid channelling device is disposed within the thermal energy storage medium with the longitudinally spaced protuberant regions in contact with the medium, and arranged to receive the working fluid. In some embodiments, the heating system is a solar energy collector system. In some embodiments, the thermal energy storage medium is an earthen structure composed substantially of conductive inorganic mineral material. In some embodiments, the thermal energy storage medium is a granular thermal energy storage medium as described herein.

In another aspect of the invention is a steam plant comprising: a heating system for heating water, wherein steam is delivered to an outlet; and a thermal energy storage system located in circuit between the heating system and the outlet, wherein the thermal energy storage system comprises: a thermal energy storage medium, and at least one fluid channelling device comprising first and second spaced-apart conduit portions and a plurality of linking conduits extending between and interconnecting the first and second conduit portions in fluid passage communication, wherein at least some of the linking conduits have longitudinally spaced protuberant regions, wherein the at least one fluid channelling device is disposed within the thermal energy storage medium with the longitudinally spaced protuberant regions in contact with the medium, and arranged to receive the steam. In some embodiments, the heating system is a solar energy collector system.

In another aspect of the invention is a thermal energy storage system comprising: a thermal energy storage medium comprising one or more discrete thermally conductive components having an average thermal conductivity k₁; one or more conduits disposed within the medium and arranged to carry a working fluid through the medium; and a thermally conductive heat transfer element having a thermal conductivity k₂>k₁ located in heat exchange relationship with at least some of the conduits, the heat transfer element extending through a portion of the medium and being arranged in use to transfer thermal energy reversibly between the working fluid and the medium components. In some embodiments, the heating system is a solar energy collector system.

In another aspect of the invention is a thermal power plant comprising: a turbine; a heating system for heating a working fluid to be employed as an energy source for the turbine; and a thermal energy storage system located in circuit between the heating system and the turbine, wherein the thermal energy storage system comprises one or more discrete thermally conductive components having an average thermal conductivity k₁; one or more conduits disposed within the medium and arranged to carry a working fluid through the medium; and a thermally conductive heat transfer element having a thermal conductivity k₂>k₁ located in heat exchange relationship with at least some of the conduits, the heat transfer element extending through a portion of the medium and being arranged in use to transfer thermal energy reversibly between the working fluid and the medium components. In some embodiments, the heating system is a solar energy collector system.

In another aspect of the invention is a steam plant, comprising: a heating system for heating water, wherein steam is delivered to an outlet; and a thermal energy storage system located in circuit between the heating system and the outlet, wherein the thermal energy storage system comprises one or more discrete thermally conductive components having an average thermal conductivity k₁; one or more conduits disposed within the medium and arranged to carry a working fluid through the medium; and a thermally conductive heat transfer element having a thermal conductivity k₂>k₁ located in heat exchange relationship with at least some of the conduits, the heat transfer element extending through a portion of the medium and being arranged in use to transfer thermal energy reversibly between the water or steam and the medium components. In some embodiments, the heating system is a solar energy collector system.

In another aspect of the invention is a thermal power plant comprising: (a) means for generating rotary power; (b) means for heating a working fluid to be employed as an energy source for the rotary power generating means; (c) a plurality of conduits located in circuit between the heating means and the rotary power generating means for carrying the working fluid between the heating means and the rotary power generating means; and (d) a thermal energy storage system located in circuit between the heating means and the rotary power generating means, wherein the thermal energy storage system comprises a thermal energy storage system as described herein.

In another aspect of the invention is a method of storing thermal energy that is carried by a working fluid in a thermal power plant; wherein the working fluid is carried by way of a plurality of conduits into an earthen structure composed substantially of conductive inorganic mineral material, with a portion of the length of the plurality of conduits being buried within the earthen structure in contacting relationship with the mineral material.

In another aspect of the invention is a thermal power plant comprising: (a) means for generating rotary power; (b) means for heating a working fluid to be employed as an energy source for the rotary power generating means; (c) a plurality of conduits located in circuit between the heating means and the rotary power generating means for carrying the working fluid between the heating means and the rotary power generating means; and (d) a thermal energy storage system located in circuit between the heating means and the rotary power generating means, wherein the thermal energy storage system comprises: an earthen structure composed substantially of conductive inorganic mineral material, and a portion of the length of the plurality of conduits buried within the earthen structure in contact with the mineral material.

In another aspect of the invention is a thermal power plant comprising: (a) a turbine; (b) at least one heating system for generating a working fluid to be employed as an energy source for the turbine; (c) a plurality of conduits located in circuit between the heating system and the turbine for carrying the working fluid between the heating system and the turbine; and (d) a thermal energy storage system located in circuit between the heating system and the turbine, wherein the thermal energy storage system comprises: an earthen structure composed substantially of conductive inorganic mineral material, and a portion of the length of the plurality of conduits buried within the earthen structure in contact with the mineral material.

In use of the invention (in its various aspects) as above defined, thermal energy from the working fluid is transferred to and stored in the energy storage system for use as and when required. Additionally, excess thermal energy from the working fluid may be transferred to and stored in the energy storage system when the available thermal energy exceeds load power demand, under either static or dynamic conditions. Thus, depending upon the storage capacity of the energy storage system, the system may be employed as a short-term buffer system or as a system that facilitates round the clock supply when using a discontinuous heating system such as that available from solar radiation.

### BRIEF DESCRIPTION OF THE DRAWINGS

FIG. 1 shows a block-diagrammatic representation of elemental components of a thermal power plant.

FIG. 2 shows a schematic representation of one embodiment of a heating system portion of the thermal power plant, the heating system being in the form of a solar energy collector system and being illustrated in an operating condition.

FIG. 3 shows a perspective view of a portion of one embodiment of the heating system of FIG. 2.

FIG. 4 shows a schematic representation of one embodiment of the heating system when in the form of a twin-field solar collector system.

FIG. 5 shows a scrap view of two receivers of the FIG. 4 system and associated working fluid conduits as encircled by circle A in FIG. 4.

FIG. 6 shows a scrap view of two receivers of the FIG. 4 system and associated working fluid conduits as encircled by circle B in FIG. 4.

FIG. 7 shows a scrap view of a portion of the length of one embodiment of a working fluid conduit, wherein the conduit comprises a water-steam separator.

FIG. 8 shows a diagrammatic sectional end view of an example of a group of the working fluid conduits in a thermal energy storage system.

FIG. 9 shows a more detailed diagrammatic end view of one embodiment of a group of the working fluid conduits comprising thermally conductive heat transfer elements in a (small, representative, portion of a) thermal energy storage system.

FIG. 10 shows a diagrammatic plan view of one embodiment of a conduit arrangement that forms a part of one unit of the thermal energy storage system.

FIG. 11 shows a diagrammatic plan view of a portion of one embodiment of a fluid channelling device arrangement in a thermal energy storage system, wherein the fluid channelling devices comprises longitudinally spaced protuberant regions.

FIG. 12 shows a diagrammatic elevation view of a portion of the thermal energy storage system of FIG. 11.

FIG. 13 shows a scrap view of an upper portion of a fluid channelling device that is incorporated in the storage system of FIGS. 11 and 12.

FIG. 14 shows a schematic representation of one arrangement of a thermal energy storage system as incorporated in the power plant.

FIG. 15 shows a schematic representation of another arrangement of a thermal energy storage system.

### DETAILED DESCRIPTION OF THE INVENTION

The invention comprises various thermal energy storage systems, methods of their use, and thermal power and steam plants incorporating said thermal energy storage systems. In thermal energy storage systems, thermal energy carried by a heated working fluid is stored in the storage system for later use, for example, under base load or peak load conditions of a power plant when using a discontinuous heating system such as one relying upon solar radiation.

Unless defined otherwise or clearly indicated by context, all technical and scientific terms used herein have the same meaning as commonly understood by one of ordinary skill in the art to which this invention belongs.

Unless otherwise indicated, all numbers used in the specification and claims are to be understood as being modified in all instances by the term “about.” Accordingly, unless indicated to the contrary, the numerical parameters set forth in the following specification and attached claims are approximations that may vary depending at least upon the specific analytical technique.

Various embodiments of the present invention are hereinafter described by way of example in the context of a thermal power plant (e.g. a Rankine cycle plant) that incorporates a solar energy collector system. However, the thermal energy storage systems described herein may also be used in the context of a steam plant, nuclear reactor, package boiler, and the like. Additionally, other heating systems, such as fossil fuel fired boilers, geothermal boilers, or a nuclear-reactor powered plant that is arranged to exchange thermal energy (heat) with the working fluid may be used to provide thermal energy to the storage system. It is to be understood that the following description for the thermal power plants of the invention also applies to the steam plants of the invention, with the exception that in the case of steam plants, the working fluid is water, and the steam is utilized directly (e.g. for industrial process heat, absorption cooling, food processing, sterilization, water desalination, chemical processing), rather than directing it through a turbine for the production of electricity. The description is provided by way of examples and with reference to the accompanying drawings, which characterizes some preferred embodiments but is by no means limiting.

The solar energy collector system may comprise, for example, a Compact Linear Fresnel Collector (CLFR) system employing a field of reflectors and elevated receivers that are illuminated by reflected radiation for energy exchange with a fluid that is carried through the receivers, and, here again, the present invention is hereinafter described by way of example in relation to a CLFR system. However, it is to be understood that various other solar energy collector systems, such as various linear Fresnel, heliostat, and trough (e.g. parabolic trough) systems may be used, including those described in International Patent Application No. PCT/AU2008/______, entitled “Solar Energy Collector Heliostats” filed Jan. 29, 2008, which claims priority from Australian Provisional Patent Application No. 2007900391, filed Jan. 29, 2007; and in International Patent Application No. PCT/AU2008/000096, entitled “Solar Energy Collector Field Incorporating Collision Avoidance” filed Jan. 29, 2008, which claims priority from Australian Provisional Patent Application No. 2007900390, filed Jan. 29, 2007, the disclosures of which are herein incorporated by reference in their entirety, which describe various 2-axes heliostat reflector systems. Additional systems include those described in U.S. patent application titled “Combined Cycle Power Plant,” filed on Jun. 6, 2008; and in U.S. patent application Ser. Nos. 12/012,920; 12/012,829; and 12/012,821; the disclosures of which are herein incorporated by reference in their entirety

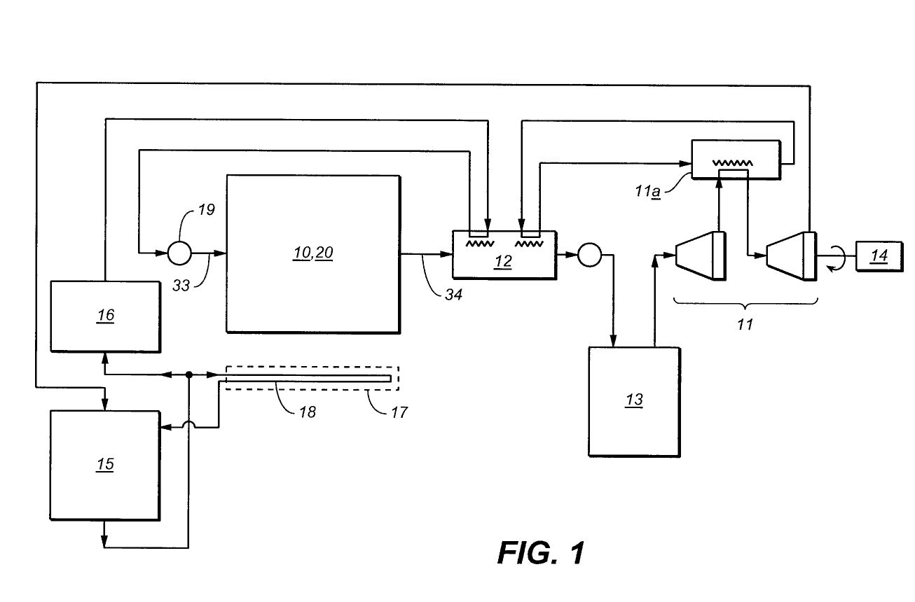

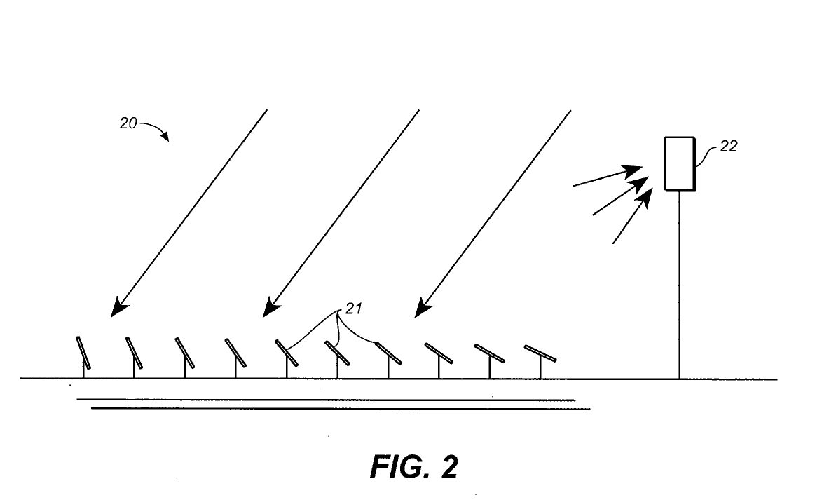

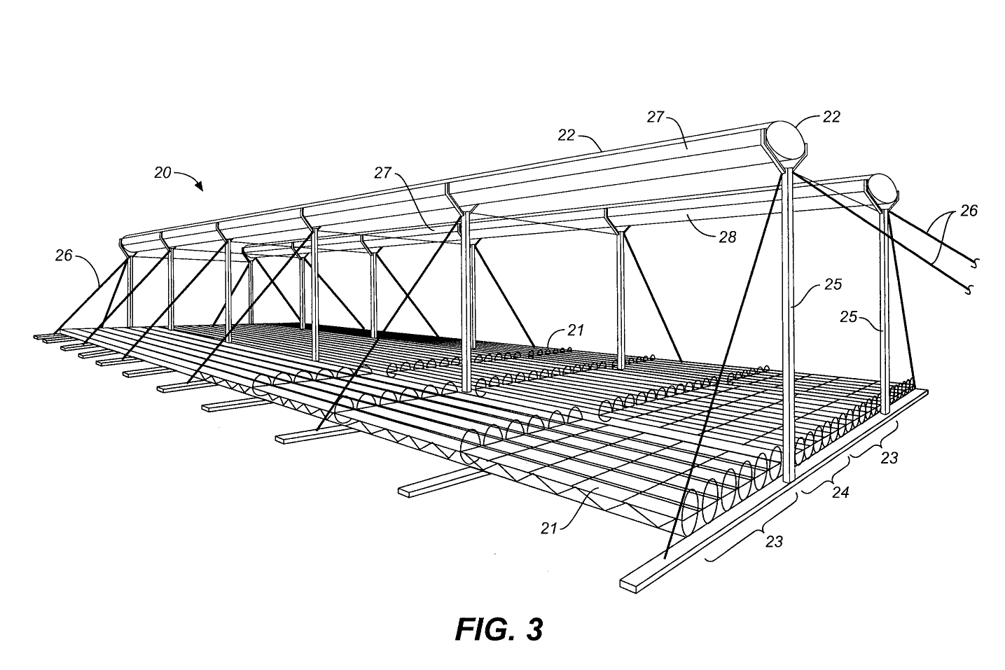

As illustrated in FIG. 1, in one embodiment the thermal power plant comprises a heating system 10 in which thermal energy is transferred to a working fluid. The heating system utilizes solar energy, examples of which are hereinafter described more fully with reference to FIGS. 2 and 3. The working fluid when heated is delivered to a two-stage steam turbine 11 by way of at least one of two thermal energy storage systems 12 and 13, although the power plant may also comprise a bypass to send the working fluid directly to the turbine when it is desired, rather than storing the thermal energy for future use. A thermal power plant may also incorporate a single or more than two thermal energy storage systems. The steam turbine may incorporate an inter-stage re-heater 11a and is employed to drive an electrical generator 14.

The working fluid in this described embodiment comprises water or, in its vapour/gaseous phase, steam. However, the working fluid might, in an alternative embodiment of the invention, comprise a hydrocarbon (e.g. pentane), carbon dioxide, air, or such other fluid as is suitable for expanding through a turbine. In some embodiments, the working fluid comprises a hydrocarbon. In some embodiments, the working fluid comprises water. In some embodiments, the working fluid comprises a water mixture (e.g. water plus ammonia). When the working fluid is not directed to a turbine, the working fluid may comprise fluidized sand.

In some embodiments, the working fluid may be heated by passing it through the (at least one) receiver of the solar energy collector system. In some embodiments, the working fluid may be heated by exchanging heat (e.g. within a heat exchanger system) between an intermediate fluid (“heat exchange fluid”), that is passed through and heated by the receiver, and the working fluid. Suitable fluids for use as a heat exchange fluid include, for example, water, water mixtures (e.g. water plus ammonia), a liquid hydrocarbon (e.g. a heat transfer oil), mineral oil, or silicone oil. The working fluid and heat exchange fluid may comprise the same type of fluid or may comprise different fluids, for example, in some embodiments the working fluid may comprise water and the heat exchange fluid may comprise oil. In some embodiments, the solar energy collector system is a linear Fresnel system, and the working fluid is heated by passing it through the (at least one) receiver of the solar energy collector system. In some embodiments, the solar energy collector system is a parabolic trough system, and the working fluid is heated by heat exchange with a heat exchange fluid.

Having expanded through the turbine, the working fluid may be directed to a condenser 15 where residual vapour is condensed to a liquid phase. From the condenser 15 the working fluid may be returned to the heating system 10 by way of an optional condensate reservoir 16 (which accommodates fluctuations in the level of the working fluid in various parts of the plant and provides for balancing of transport of the working fluid) and, optionally, by way of the energy storage system 12.

Both the turbine 11 and the condenser 15 are selected to meet design parameters as determined, for example, by required output power, operating temperature and operating pressure. Similarly, the heating system 10 is designed to provide for delivery of the working fluid vapour (e.g. steam) at a mass flow rate matched to the demand of the power plant.

The condenser 15 may comprise one in which the working fluid and a coolant fluid are channelled through separate circuits. The condenser 15 may comprise a direct contact condenser that incorporates a subterranean cooling system of the type disclosed in International Patent Application PCT/AU2007/000268. Thus, the cooling system for the condenser coolant may comprise a heat exchanger 17 that forms a part of a cooling system loop 18 through which the coolant fluid is recirculated when cycling through the condenser. The heat exchanger 17 is buried within ground that is located at least in part below reflector elements (hereinafter referred to) of the heating system 10. The cooling system for the condenser coolant may also comprise dry cooling units that are located at least partially above ground level in a solar energy reflector field associated with the heating system 10 or it may be embodied in a convection/radiative cooling system that is integrated with solar energy reflectors within the heating system, such as described in the co-owned U.S. patent application titled “Convective/Radiative Cooling of Condenser Coolant” filed Jun. 6, 2008.

Ancillary equipment, such as valves and metering devices, as would normally be included in a thermal power plant have been omitted from FIG. 1 as being unnecessary for an understanding of the invention, as have connections and valving arrangements that might be provided for by-passing one or the other or both of the thermal energy storage systems 12 and 13 and for feeding the steam turbine 11 directly from the heating system 10.

In various examples of the operation of the plant as described thus far, water at a temperature of, for example, about 30° C. to about 50° C., about 35° C. to about 65° C., is conveyed to the heating system 10, by way of a pump 19, where it is heated to a temperature in the range of about 180° C. to about 600° C., although higher and lower temperatures are feasible. In various embodiments, the water is heated to a temperature in the range of about 180° C. to about 340° C., about 180° C. to about 500° C., about 200° C. to about 400° C., about 200° C. to about 420° C., about 210° C. to about 310° C., about 220° C. to about 280° C., about 220° C. to about 310° C., about 220° C. to about 311° C., about 220° C. to about 320° C., about 220° C. to about 370° C., about 220° C. to about 450° C., about 220° C. to about 500° C., about 270° C. to about 340° C., about 270° C. to about 370° C., about 270° C. to about 400° C., about 270° C. to about 420° C., about 280° C. to about 500° C., about 300° C. to about 600° C., about 311° C. to about 370° C., about 311° C. to about 450° C., about 350° C. to about 410° C. Various temperatures may be desired, depending on whether saturated, a combination of saturated and supersaturated, or supersaturated steam is desired. Steam and vapour from the heating system is delivered to one or other or both of the thermal energy storage systems 12 and/or 13 under pressure of, for example, about 10 to about 150 Bar, about 20 to about 150 Bar, about 20 to 100 Bar, about 25 to about 150 Bar, about 70 to about 100 Bar. It is to be understood that the operating temperatures and pressures of the working fluid may vary according to the particular working fluid used, the type of solar energy reflector system, the configuration of the thermal power plant, etc.

When, as described in the above example, the working fluid comprises water, flash steam from the thermal energy storage system 13 may be conveyed to the turbine 11 by a conduit. After expanding through the turbine the exiting vapour may be directed into the condenser 15 and to a following condensate reservoir 16. The reservoir 16 may accommodate fluctuations in the level of working fluid in the thermal energy storage system 13 and provide for balancing of transport of the working fluid throughout the plant.

The heating system 10 in some embodiments comprises a solar energy collector system, an example of which is described below. It is to be understood that various other solar energy collector systems 10 may be utilized in the invention, including but not limited to various linear Fresnel systems, heliostat systems, and trough systems (e.g. parabolic trough systems). The solar energy collector system generally comprises a reflector (for reflecting the solar energy to a particular location) and a receiver (for receiving the reflected solar energy and heating the working fluid or heat exchange fluid). The reflector may be remote from and move independently of the receiver, or may be directly connected to and move with the receiver. In some embodiments, the solar energy collector system comprises a linear Fresnel system. In some embodiments, the solar energy collector system comprises a heliostat system. In some embodiments, the solar energy collector system comprises a parabolic trough system. In some embodiments, the solar energy collector system comprises a dish system. In the case of a thermal power plant having a field of solar energy reflectors, the reflectors are optionally arrayed in parallel rows and each reflector may pivot about one or more axes, such as a horizontal axis. In some embodiments, the reflectors are arrayed in a spiral or concentric circles about a receiver.

One example of the heating system 10, in the form of a CLFR solar energy collector system 20, is illustrated in a diagrammatic way in FIG. 2 and a small (representative) portion of the solar collector system is illustrated in a more factual way in FIG. 3. The solar energy collector system in this embodiment comprises a field of arrayed ground-mounted, pivotal reflectors 21 that are driven to track the sun and, in so doing, reflect incident solar radiation to illuminate an elevated receiver system 22. In the form illustrated, the reflectors 21 pivot about horizontal axes.

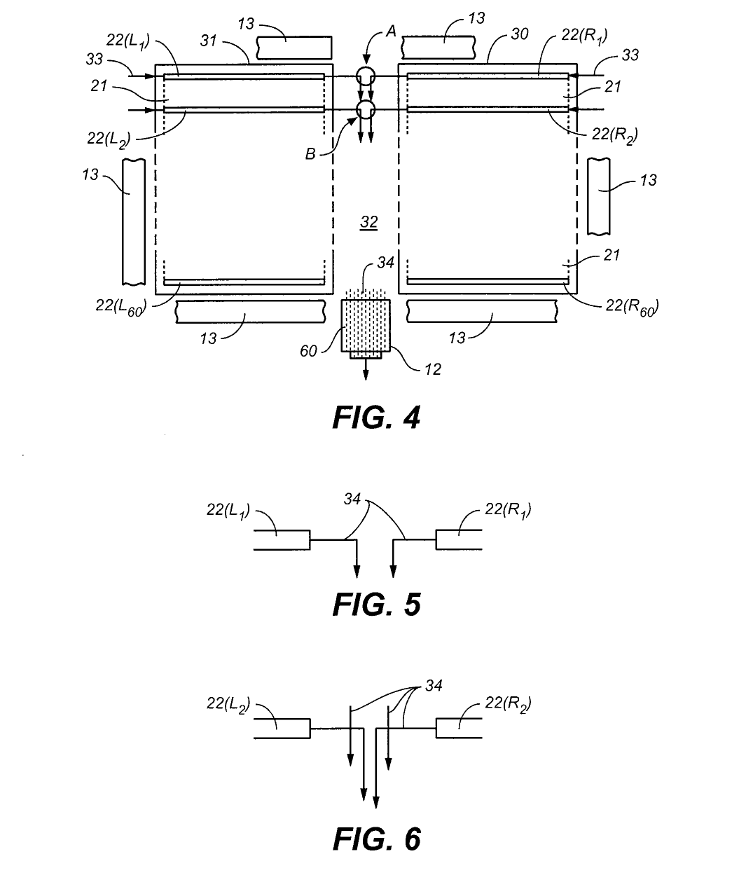

As shown in more detail in FIG. 3, the representative portion of the solar collector system 20 may comprise two notionally separate regions 23 and 24 of ground mounted reflectors 21 that are located in parallel rows that extend generally in the north-south direction, although they may, when appropriately spaced, extend generally in an east-west direction. Also, the portion of solar collector system as illustrated in FIG. 3 comprises two parallel receivers 22. The complete solar energy collector system might, for example, occupy a ground area within the range of about 50×10³ m² to about 50×10⁶ m² and the system as shown in FIG. 4 may comprise a representative portion only of the complete solar energy collector system.

In the system as illustrated in FIG. 3, each receiver 22 receives reflected radiation from twelve rows of reflectors 21. Thus, each receiver 22 is illuminated by reflected radiation from six rows of reflectors 21 at one side (e.g., region 23) of the receiver system and from six rows of reflectors 21 at the other side (e.g., region 24). Each row of the reflectors 21 and, hence, each receiver 22 might typically have an overall length of 200 to 600 metres, and the parallel, north-south extending receivers 22 might typically be spaced apart by 30 to 35 metres. The receivers 22 are supported at a height of approximately 11 to 15 metres by stanchions 25 which are stayed by ground-anchored guy wires 26.

Each of the receivers 22 comprises an inverted trough 27 which is closed at its underside by a longitudinally extending window 28. The window is formed from a sheet of material that is substantially transparent to solar radiation and it functions to define a closed (heat retaining) longitudinally extending cavity within the trough 27. Longitudinally extending stainless steel absorber tubes (not shown but typically between five and twenty such tubes) are located in the trough 27 for carrying the working fluid.

Any suitable reflector and receiver structures may be used in the invention. In some embodiments, the reflectors 21 comprise units as disclosed in International Patent Applications PCT/AU2004/000883 and PCT/AU2004/000884, the disclosures of which are herein incorporated by reference in their entirety. In some embodiments, the receiver systems 22 comprise systems as disclosed in International Application PCT/AU2005/000208, the disclosure of which is herein incorporated by reference in its entirety. International Patent Application No. PCT/AU2008/______, entitled “Solar Energy Collector Heliostats” filed Jan. 29, 2008, which claims priority from Australian Provisional Patent Application No. 2007900391, filed Jan. 29, 2007; and in International Patent Application No. PCT/AU2008/000096, entitled “Solar Energy Collector Field Incorporating Collision Avoidance” filed Jan. 29, 2008, which claims priority from Australian Provisional Patent Application No. 2007900390, filed Jan. 29, 2007, the disclosures of which are herein incorporated by reference in their entirety, and which describe various 2-axes heliostat reflector systems.

The complete solar collector system 20, in comprising many multiples of the portion of the system as illustrated in FIG. 3, might, in the case of a 100 MWe power plant, occupy a ground area within the range 1.4×10⁶ m² to 1.8×10⁶ m². Such a system is illustrated in a schematic way in FIG. 4, which shows two adjacent collector system fields 30 and 31 which are separated by a roadway or corridor 32. As indicated previously, the size of the fields will be determined by the output capacity of the plant but the two fields 30 and 31 might each contain sixty parallel receiver systems 22(R₁) to 22(R₆₀) and 22(L₁) to 22(L₆₀). Twelve parallel rows of reflectors 21 may be located between successive pairs of receiver systems, such as in the arrangement shown in FIG. 3.

Feed water for the multiple absorber tubes (not shown) in each of the receivers 22 is indicated (for convenience of illustration) as being delivered to the outer end 33 of each of the receivers 22, and the heated working fluid (e.g. a superheated steam, a mixture of steam and saturated vapour, or hot water) is recovered from the corridor end 32 of each of the receivers. This latter arrangement is illustrated in a diagrammatic way in FIG. 5 and FIG. 6, which shows a single (representative) working fluid delivery conduit 34 exiting from each of the receivers 22(R₁) and 22(L₁). In fact the single illustrated conduit 34 from each receiver is representative of as many conduits as there are absorber tubes within the receivers. Thus, if for example, there are five absorber tubes in each receiver 22, a total of ten conduits 34 will enter the corridor 32 from each pair of aligned receivers 22(R) and 22(L), and a total of six hundred conduits 34 will enter the corridor 32 from the one-hundred-and-twenty receivers 22 located in the two fields 30 and 31. The conduits 34 drop vertically from the elevated receivers to ground level and extend along the length of the corridor 32 to the energy storage system 12.

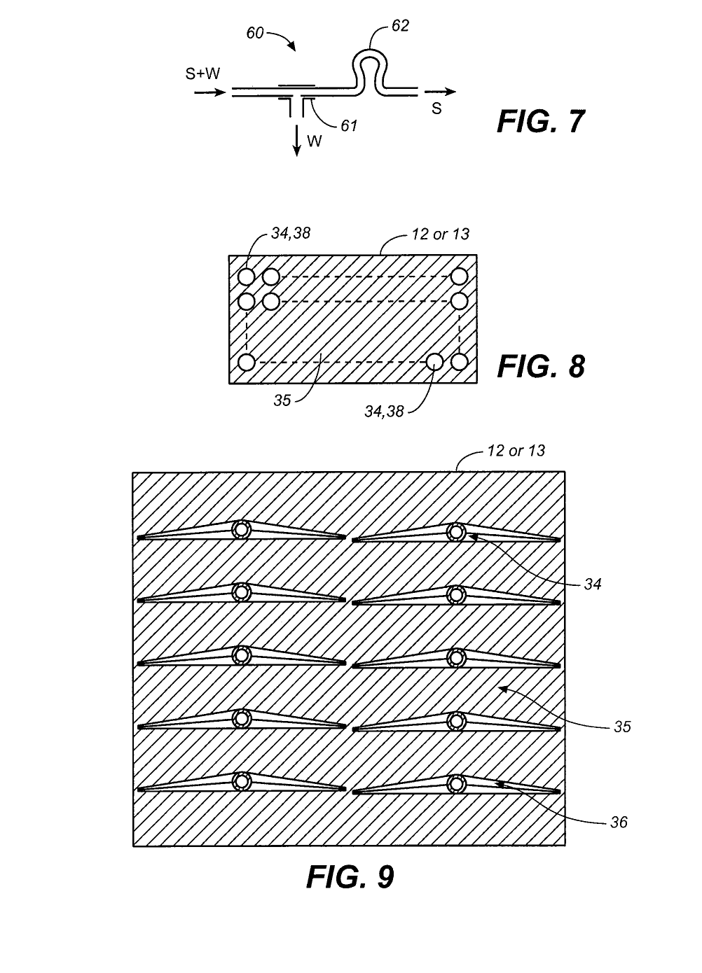

Water-steam separators 60 comprising T-junctions 61 and expansion absorbers 62 may be located at incremental positions along the length of each of the conduits, as shown diagrammatically in FIG. 7.

In one illustrative example as shown in FIG. 6, the conduits 34 that enter the corridor 32 from receivers 22 that are progressively closer to the energy storage system 12 may be positioned spatially within the conduits that enter the corridor from progressively more distant positions. Thus, the groups of conduits 34 that extend a shorter distance toward the energy storage system 12 (and which suffer the least loss of heat) may be positioned spatially within the groups of conduits that extend for longer distances. As will be apparent to one of ordinary skill in the art, this is but one example, and other conduit configurations may be used. As indicated in FIG. 8 the six-hundred conduits 34 (as seen in end elevation) may be arranged in a 2-dimensional array composed of twenty rows, each containing 30 conduits within a storage medium 35. Although dependent on system capacity and design criteria, the conduits may have in some embodiments about a 50 mm bore, about a 2.77 mm wall thickness and, in the storage medium, about a 220 mm centre-to-centre spacing.

The thermal energy storage system 12 is, in this illustrative embodiment of the invention, provided as a buffer storage, for example to be accessed during transitory time periods (of e.g. about 30 minutes to about 3 hours) during which the heating system 10 (in this embodiment solar energy collector 20) may not be able to match the requirements for a given load demand. This might occur when solar radiation is attenuated by transitory cloud cover or when a transitory load demand exceeds the steady state capacity of the system.

In contrast, the thermal energy storage system 13 may be provided for longer-time storage, for example 3 hours to 24 hours base load storage. The storage system 13 may comprise, for example, a variation of the system as above described, a larger capacity system of the type as above described or a system such as that disclosed in Australian Provisional Patent applications 2006903801 and 2006905367 dated 14 Jul. 2006 and 28 Sep. 2006 respectively. The system 13 may, as illustrated in FIG. 4, be located about the periphery of the collector system fields 30 and 31. However, it is to be understood that the systems as described thus far are but examples of many possible arrangements. The buffer and base load thermal energy storage systems 12 and 13 may be integrated and the storage systems may be constructed as modules, each of which may have conduit arrangements for example as illustrated in FIG. 8 of the drawings.

The buffer storage system 12 may be positioned within or adjacent the corridor 32 between the two fields 30 and 31 and it is constituted by the combination of: i) a thermal energy storage medium 35, and ii) a longitudinal portion 38 of the length of each of the plurality of conduits 34. The longitudinal portion 38 of each of the conduits is buried within the storage medium in heat exchange relationship with the storage medium 35, and the composite structure is surrounded by a layer of insulating material 39 (FIG. 14; FIG. 15). In some embodiments, some or all of the conduits may be replaced by the fluid channelling devices as described herein in more detail below.

As illustrated in one embodiment in FIG. 9, the thermal energy storage system 12/13 comprises the medium 35, a plurality of the conduits 34 buried within the medium and arranged to carry the working fluid through the medium, and thermally conductive heat transfer elements 36 which have a thermal conductivity k₂ within the range of, for example, about 100-400 W/m·K located in heat exchange relationship with the conduits 34. Each of the heat transfer elements 36 functions alternatingly as a heat distributor and retriever and it extends horizontally into the medium 35 for the purpose of transferring thermal energy reversibly between the working fluid in the associated conduit 34 and the discrete (thermally conductive) components of the medium. In some embodiments, the heat transfer elements are shaped as shown in FIG. 8. In some embodiments, the heat transfer elements are formed as substantially flat sheets to overlie each of the conduits along at least a major portion of the lengths of the conduits within the storage system, as indicated in FIG. 9.

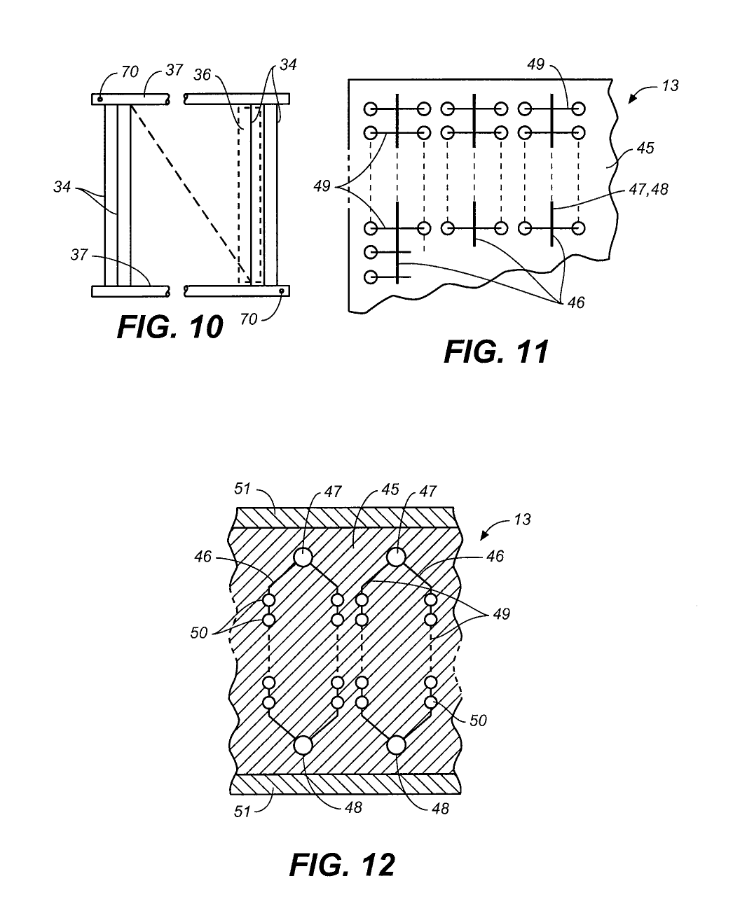

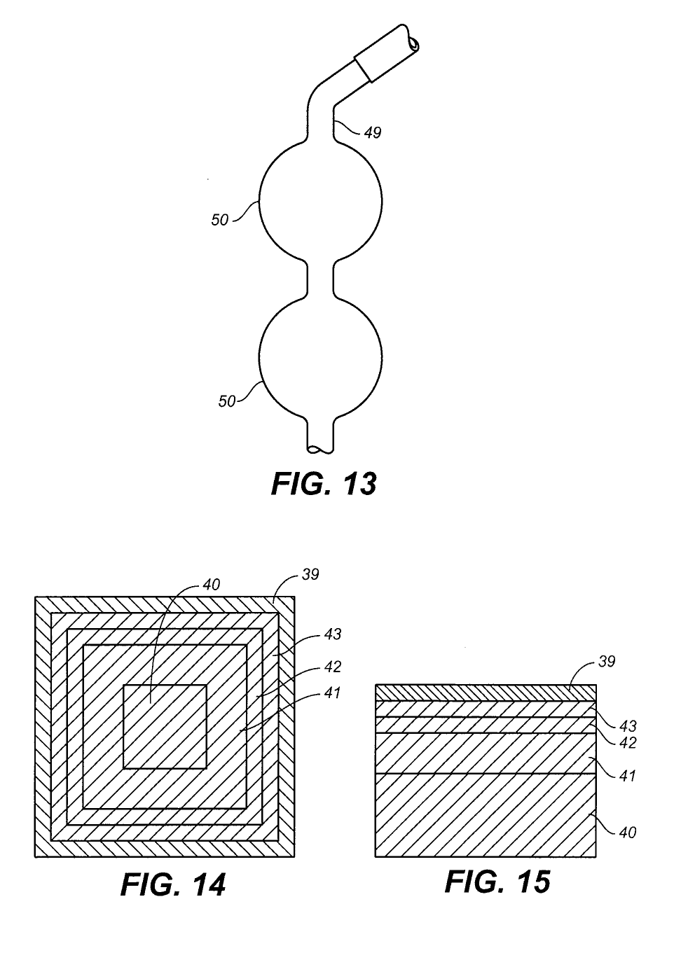

The thermal energy storage system 12/13 may be constructed as an assembly of modules, each having a generally cubic form with 12 m side dimensions, and each containing a conduit assembly as shown in plan in FIG. 10. The conduit assembly may comprise eighty horizontal layers of conduits 34 and manifolds 37, with each layer also comprising eighty conduits extending between two manifolds 37. Downpipes 70 interconnect the manifolds of the respective layers.

The thermal energy storage system may be located at least in part above the local ground level, or be located below ground level and integrated in the localised ground so that the ground itself forms an extension of the thermal energy storage system.

Particulate insulating material (e.g. relatively non-conductive material) or a mat-type insulating material (not shown) may be located about and/or over the top of the thermal energy storage system. Such insulating material optionally comprises sand and/or rock dust and the upper region of the storage system may optionally comprise a higher grade insulating material and may be positioned upon an upper region of the storage system, at or a small distance below ground level.

In an alternative, non-illustrated, embodiment of the above described arrangement, the thermal energy storage system 12 may be positioned at the periphery of one or the other or both of the fields 30 and 31 or to extend around at least a portion of the periphery of the fields. Thus, the storage system may be sized to provide whatever capacity may be required for a given plant operation.

FIG. 14 provides a schematic end-elevation representation of one embodiment of the structure of the storage system 12. In this example, the innermost region 40 of the structure is occupied by the conduits 34 that extend the least distance to the storage system 12 from the receivers and, thus, are at the highest temperature. The surrounding region 41 is occupied by the conduits 34 that extend for progressively longer distances and which, therefore, are at a lower temperature. Those conduits are in turn surrounded by region 42 which is occupied by piping associated with the re-heater 11a (see FIG. 1), and the re-heater piping is surrounded by a region 43 that is occupied by the receivers' feedwater piping 33. The outermost region is occupied by the insulating material 39.

FIG. 15 shows a schematic representation of a second, alternative, structure of the thermal energy storage system 12, in which the lowermost region 40 of the structure is occupied by the conduits 34 that extend the least distance to the storage system 12 from the receivers and, thus, are at the highest temperature. The next highest region 41 is occupied by the conduits 34 that extend for progressively longer distances and which, therefore, are at a lower temperature. Those conduits are in turn surmounted by region 42 which is occupied by piping associated with the re-heater 11a, and the re-heater piping is in turn surmounted by a region 43 that is occupied by the receivers' feedwater piping 33. The uppermost region is occupied by the insulating material 39 and, in an alternative non-illustrated arrangement, the insulating material 39 may be positioned to surround the remaining structure.

### Thermal Energy Storage Mediums

When used in the context of an element of a thermal energy storage medium, “material” as used herein indicates e.g. rock, gravel, sand, silt, soil, as well as specific types, chemical compositions, or isolated fractions thereof. Thus, a “material” may be, for example, rock, quartzite rock, or clay (e.g. clay may be an isolated fraction of some soils). When used in the context of an element of a thermal energy storage medium, “component” as used herein indicates a particular material of a particular size class (i.e. having a particular size range for the component particles). For example, a component may be sand of about 0.1 to about 2 mm in size. In another example, a component may be basalt rock of about 50 to about 60 mm in size.

In general, a thermal energy storage medium (comprising one or more components) may comprise any medium useful for thermal energy storage, including the granular thermal energy storage mediums described herein. Additional examples of thermal energy storage mediums include concrete, sand, and an earthen structure composed substantially of conductive inorganic mineral material, as further described below. Granular thermal energy storage mediums comprise one or more granular components, and lack a binding material such as cement or hydrated lime. Thus, a thermal energy storage system comprising a granular thermal energy storage medium excludes conduits disposed within and closely bound by concrete. Granular storage mediums permit relative movement of the various components of the thermal energy storage system, including longitudinal movement of the conduits, as caused by thermal expansion within the medium. A granular storage medium maintains its granular integrity through complete thermal cycles, and additionally maintains its granular integrity if exposed to water. The granular storage mediums as described herein may optionally be used as a constituent in a thermal storage system as described in the co-owned U.S. Provisional Patent Application titled “Thermal Energy Storage System Comprising Varying Physical Properties and Methods For Use”, filed Jun. 6, 2008. Briefly, this storage system comprises a thermal energy storage medium comprising two or more components distributed heterogeneously within the medium such that one or more physical properties of the medium vary with distance from the one or more conduits, wherein the one or more conduits are disposed within the thermal energy storage medium. For example, a component such as hematite, alumina, or periclase may be located concentrically about the conduits, with the remaining volume of the storage system occupied by a granular thermal energy storage medium as described herein.

Various materials, for example, inorganic minerals and earthen materials (e.g. topsoil and/or subsoil and/or individual materials of topsoil and/or subsoil and/or rock and/or gravel) may be useful in storage mediums. Non-limiting examples of materials which may be useful include, for example, aggregate (e.g. rock (e.g. quartzite, granite, basalt, silicates, limestone, shale, hematite, alumina, periclase (MgO), etc.), gravel (e.g. quartzite, granite, basalt, silicates, limestone, shale, hematite, alumina, periclase (MgO), etc.), concrete pieces), sand, soil (e.g. topsoil and/or subsoil), clay, silt, soil organic material, metals, metal oxides (e.g. hematite, ironsand, alumina, periclase (MgO)), glass (e.g. recycled glass), silicates, metal carbonates, graphite, metal nitrates, metal nitrites, metal nitrides (e.g. aluminium nitride), molten salts, soluble minerals (e.g. soluble carbonates and nitrates), and liquids (e.g. silicone, mineral oil, glycerol, sugar alcohols, retene, tetracosane). Rock generally comprises particles which are greater than about 50 mm in size. In some embodiments, rock comprises granite, quartzite, basalt, a silicate, carbonate, nitrate, and/or oxide. In some embodiments, rock comprises granite, quartzite, basalt, and/or silicates. In some embodiments, rock comprises a carbonate, nitrate, and/or oxide which is naturally present in rock. In some embodiments, rock comprises a carbonate and/or oxide which is naturally present in rock. Gravel generally comprises the same materials as rock, with a size range of about 2 mm to about 50 mm. “Medium gravel” comprises gravel of about 25 mm. “Fine gravel” comprises gravel of about 6 mm. Sand frequently comprises a high percentage of silicates, but may in addition to or instead of silicates, may comprise one or more of any of the materials of rock or gravel, with a size range of about 0.06 mm to about 2 mm. “Coarse sand” comprises sand of about 1.5 mm. “Fine sand” comprises sand of about 0.3 mm. “Very fine sand” comprises sand of about 0.08 mm. Silt comprises particles of about 4 microns to about 60 microns, and may comprise organic material and/or any of the materials of rock, gravel, or sand. Generally, while the specific composition of “soil” may vary depending on the location of the soil sample, soil may comprise one but in general soil comprises a mixture of two or more (e.g. three, four, or more) of the following: rock, gravel, sand, clay, silt, and organic material. When soil is used as a material, the soil may be unwashed or washed (e.g. to remove organic material and/or clay).

Rock may in some embodiments be monolithic rock, crushed rock and/or quartzite. Gravel may in some embodiments be monolithic gravel, crushed gravel and/or quartzite. Quartzite has the highest conductivity at 250° C. of all the types of minerals reported by Clauser and Huenges in their 1995 paper titled “Thermal Conductivity of Rocks and Minerals”, Rock Physics and Phase Relations, A Handbook of Physical Constants, American Geophysical Union (1995), the disclosure of which is herein incorporated by reference in its entirety. The conductivity of the quartzitic minerals, at 250° C., is between about 2.5 and about 4 W/(m·K).

The “size” of a particle of a material may be either the length of the longest dimension of the particle, or when the particle is spherical or approximately spherical, may be the diameter of the particle. In some embodiments, the size is the length of the longest dimension. In some embodiments, the size is the diameter.

The various materials may be used alone or be mixed, and may be used in their naturally occurring form, in crushed form, or in a consolidated form, such as in the form of bricks or blocks, provided that when the thermal energy storage medium is a granular thermal energy storage medium, the consolidated forms are granular materials of the medium (i.e. the medium as a whole is not bound together, such as with conduits encased in concrete). The medium materials when in consolidated form may comprise, for example, concrete blocks composed of low fraction cement, or bricks formed from, for example, bonded aluminium oxide particles. The materials may in some embodiments be smoothed, either naturally (e.g. river pebbles) or artificially.

Additionally, the medium may optionally be wet or dry compacted to maximize density and conductivity, but this compaction may be moderated to avoid frictional stress on the conduits, and additionally, in the case of granular thermal energy mediums, the medium will retain its granular integrity after exposure to water. When wet compaction is used, the inclusion of the smallest particles, in particular of clays, of less than about 15 microns, in some embodiments less than about 10 microns, may facilitate compaction but may also lead to shrinkage on drying, causing high thermal stresses. In general, for the granular thermal energy storage mediums, when clay is present, it is present in a low enough concentration such that if the medium gets wet, the medium will retain its granular integrity and the clay will not act as a binder.

The physical properties of the overall storage medium result from the physical properties of the individual materials of the medium, as well as the size and shape of the particles of the materials which affect, for example, the void volume fraction of the medium. Without wishing to be bound by theory, in general, for a thermal energy storage medium it is preferred to use materials which increase thermal conductivity (in order to transfer heat energy quickly and efficiently), heat capacity (to increase capacity for thermal energy storage per unit volume), and density (both of the individual materials, which generally increases heat capacity, as well as for the overall medium, which reduces void volume fraction) of the storage medium. While it is generally preferred to reduce void volume fraction of the medium, in order to increase thermal contact between materials (thus increasing the effective thermal conductivity of the medium), tighter packing of the medium may also result in increased stress and/or increased abrasion on the conduits upon thermal expansion of the conduits. Thus, for a particular medium there may in some embodiments be a desirable lower limit for the void volume fraction. It may be preferred in some embodiments to select a medium that has a coefficient of thermal expansion that is similar to that of the conduits, which may result in less stress and reduced friction/abrasion on the conduits during thermal expansion of the medium and conduits. In some embodiments, it may be preferred to reduce the stiffness (modulus) of the medium, as decreasing stiffness of the medium results in less stress and reduced friction/abrasion on the conduits during thermal expansion. Additionally, it may be preferred in some embodiments to have the medium acting within an elastic range, in order to avoid permanent deformation of the medium or arrangement of the materials or components within the medium as a result of multiple thermal cycles. Higher elasticity may also result in less stress and reduced friction/abrasion on the conduits during thermal expansion. Additional characteristics which are generally preferred include thermal stability of the materials, and materials having a lack of corrosive effect and/or abrasiveness on the conduits. Abrasion can result from e.g. materials which have a surface hardness greater than the conduit, placement of large materials against the conduit, and from relative movement of the conduit against the medium upon thermal expansion (such as described above).

The various physical properties may be considered and balanced in order to select a particular storage medium that maximizes overall performance within a given set of cost and/or local, state, and/or federal restraints. For example, the medium may be produced from at least some locally available materials, in order to save costs on transporting the material. Additionally, the physical properties may be balanced in order to maximize performance of the system within a particular set of local legal codes, for example boiler codes.

A particular material has an inherent thermal conductivity which is a physical property of that particular material. The storage medium as a whole has an effective thermal conductivity, which is based on the thermal conductivities of the individual materials as well as the thermal contact between the material particles (e.g. due to size and shape of the particles). Generally, a larger sized voidless particle will have a higher effective thermal conductivity than an equivalent volume of small particles of the same type of material, as the equivalent volume of smaller particles will have lower thermal conductivity (i.e. higher thermal resistance) due to the gaps between particles and higher number of interfaces. However, small particles can fill voids and pack more tightly against e.g. irregularly shaped materials and the conduits. As noted above, increasing thermal contact increases the effective thermal conductivity of the medium, facilitating conduction of thermal energy between the working fluid and the storage region, into the medium during storage of heat in the storage region and out from the medium during recovery of heat by the working fluid.

Accordingly, in one embodiment of the invention, the size of the materials and their ratios are selected to achieve particle packing such that thermal conductivity of the overall medium is maximized. The components may be selected, for example, under a particular set of cost (e.g. cost of material as well as cost of shipment) and performance (e.g. output required, whether used for short or long term storage, etc.) constraints. For example, a small amount of very fine particles (e.g. less than about 50 microns) may significantly increase conductivity. In some embodiments, the medium comprises very fine particles. In some embodiments, the lower limit on particle size is about 20 micron (32 micron nominal size), as smaller particles may lead to high thermal stresses on the conduits due to tight packing of the medium. In some embodiments, the largest size class is selected to be as large as possible with a given set of locally available materials, cost constraints, whether the storage system will be used for short or long term storage, and the spacing of the conduits (e.g. so the materials fit between the conduits). In general, spacing the conduits more closely together may increase the response time of the thermal storage system, making it more suitable for short term storage, while spacing the pipes further apart may increase the overall energy capacity of the storage system, making it more suitable for long term storage.

In one example, the medium is an earthen structure composed substantially of conductive inorganic mineral material(s). The earthen structure may comprise, for example, crushed rock fill and the rock fill is constituted by differently sized rock particles to maximise surface contact with the conduits and between particles, to facilitate conduction of or, in other words, thermal energy exchange between the working fluid and the storage region, into the rock fill during storage of heat in the storage region and out from the rock fill during recovery of heat by the working fluid. The rock particles range in size from, for example, about 40 mm average size down to dust particle size.

Generally, it is preferred to use materials with higher thermal conductivity, within the other constraints of the system. In various embodiments, a particular material, component, or size class may have a thermal conductivity of, for example, about 0.8-2.0 W/m·K, at least about 0.1 W/m·K, at least about 0.3 W/m·K, at least about 0.4 W/m·K, at least about 0.5 W/m·K, at least about 0.6 W/m·K, at least about 0.8 W/m·K, at least about 1.0 W/m·K, at least about 1.5 W/m·K, at least about 2.0 W/m·K, at least about 2.5 W/m·K, at least about 3.0 W/m·K, at least about 3.5 W/m·K at the average temperatures at which the storage system operates. In some embodiments, the storage medium may have a thermal conductivity (i.e. the average effective thermal conductivity) of, for example, about 0.8-2.0 W/m·K, at least about 0.1 W/m·K, at least about 0.3 W/m·K, at least about 0.4 W/m·K, at least about 0.5 W/m·K, at least about 0.6 W/m·K, at least about 0.8 W/m·K, at least about 1.0 W/m·K, at least about 1.5 W/m·K, at least about 2.0 W/m·K, at least about 2.5 W/m·K, at least about 3.0 W/m·K, at least about 3.5 W/m·K at the average temperatures at which the storage system operates. While operating temperatures may vary according to the particular storage medium, conduit configuration, particular working fluid, etc., in general storage system operating temperatures may range from about 100° C. to about 1200° C. In various embodiments, the storage system operating temperatures about 100° C. to about 365° C., about 100° C. to about 374° C., about 100° C. to about 500° C., about 100° C. to about 500° C., about 120° C. to about 365° C., about 180° C. to about 280° C., about 220° C. to about 280° C., greater than about 100° C., less than about 365° C. When the working fluid is water, the storage system operating temperatures may range from about 120° C. to about 410° C., for example above about 150° C. In some embodiments, the maximum temperature difference during operation is about 370° C. In some embodiments, the maximum temperature difference during operation is about 59-60° C. In some embodiments, the maximum temperature difference during operation is within the elastic movement of the thermal storage system (e.g. the storage medium and conduit configuration).

In various embodiments, a particular material, component, or size class of the storage medium has a thermal conductivity of at least about 0.1 W/m·K at 250° C., at least about 0.3 W/m·K at 250° C., at least about 0.4 W/m·K at 250° C., at least about 0.5 W/m·K at 250° C., at least about 0.6 W/m·K at 250° C., at least about 0.7 W/m·K at 250° C., at least about 0.8 W/m·K at 250° C., at least about 0.9 W/m·K at 250° C., at least about 1.0 W/m·K at 250° C., at least about 1.5 W/m·K at 250° C., at least about 2.0 W/m·K at 250° C., at least about 2.5 W/m·K at 250° C., at least about 3.0 W/m·K at 250° C. In various embodiments, each of the materials, components, or size classes have a thermal conductivity of at least about 0.3 W/m·K at 250° C., at least about 0.4 W/m·K at 250° C., at least about 0.5 W/m·K at 250° C., at least about 0.6 W/m·K at 250° C., at least about 0.7 W/m·K at 250° C., at least about 0.8 W/m·K at 250° C., at least about 0.9 W/m·K at 250° C., at least about 1.0 W/m·K at 250° C., at least about 1.5 W/m·K at 250° C., at least about 2.0 W/m·K at 250° C., at least about 2.5 W/m·K at 250° C., at least about 3.0 W/m·K at 250° C. In various embodiments, the storage medium has a thermal conductivity of at least about 0.1 W/m·K at 250° C., at least about 0.3 W/m·K at 250° C., at least about 0.4 W/m·K at 250° C., at least about 0.5 W/m·K at 250° C., at least about 0.6 W/m·K at 250° C., at least about 0.7 W/m·K at 250° C., at least about 0.8 W/m·K at 250° C., at least about 0.9 W/m·K at 250° C., at least about 1.0 W/m·K at 250° C., at least about 1.5 W/m·K at 250° C., at least about 2.0 W/m·K at 250° C., at least about 2.5 W/m·K at 250° C., at least about 3.0 W/m·K at 250° C.

In various embodiments, a material has a volumetric heat capacity of about 500 kJ/m³K to about 5000 kJ/m³K, about 600 kJ/m³K to about 3000 kJ/m³K, about 700 kJ/m³K to about 2000 kJ/m³K, about 800 kJ/m³K to about 1000 kJ/m³K. In some embodiments, a component or size class has a volumetric heat capacity of about 500 kJ/m³K to about 5000 kJ/m³K, about 600 kJ/m³K to about 3000 kJ/m³K, about 700 kJ/m³K to about 2000 kJ/m³K, about 800 kJ/m³K to about 1000 kJ/m³K. In some embodiments, the medium as a whole has a volumetric heat capacity of about 500 kJ/m³K to about 5000 kJ/m³K, about 600 kJ/m³K to about 3000 kJ/m³K, about 700 kJ/m³K to about 2000 kJ/m³K, about 800 kJ/m³K to about 1000 kJ/m³K.

In various embodiments, the total density of the thermal energy storage medium is at least about 1000 kg/m³, at least about 1200 kg/m³, at least about 1400 kg/m³, at least about 1500 kg/m³, at least about 1600 kg/m³, at least about 1700 kg/m³, at least about 1800 kg/m³, at least about 1900 kg/m³.

In some embodiments, the medium has a coefficient of thermal expansion that deviates no more than about 75% from that of the conduits. In various embodiments, the medium has a coefficient of thermal expansion that deviates no more than about 75%, no more than about 50%, no more than about 40%, no more than about 30%, no more than about 25%, no more than about 20%, no more than about 15%, no more than about 10%, no more than about 5% from that of the conduits.

In some embodiments, the medium has a modulus of about 10 MPa to about 500 MPa. In some embodiments, the modulus is about 50 MPa to about 300 MPa.

In some embodiments, the surface hardness of a material is about 1 to about 9 on the Mho's scale. In various embodiments, the surface hardness of a material is about 1 to about 6 on the Mho's scale. The surface hardness of various materials include the following: alumina (about 9 on the Mho's scale); MgO (about 5-6 on the Mho's scale); quartz (about 7 on the Mho's scale); basalt (about 4-6.5 on the Mho's scale); shale (about 2-3 on the Mho's scale).

The void volume fraction of the storage medium in general may be less than about 30%. In various embodiments, the void volume fraction of a storage medium may be less than about 25%, less than about 20%, less than about 18%, less than about 15%, less than about 12%, less than about 10%, less than about 9%, less than about 8%, less than about 7%, less than about 6%, less than about 5%, less than about 4%, less than about 3%, less than about 2%, less than about 1%, less than about 0.5%. In various embodiments, the void volume fraction of the storage medium may be at least about 0.5%, at least about 1%, at least about 2%, at least about 3%, at least about 4%, at least about 5%.

The individual granules for a particular size class may deviate from the average size for that size class by no more than about ±50%. In various embodiments, the individual granules for a particular size class may deviate from the average size for that size class by no more than about ±45%, by no more than about ±40%, by no more than about ±35%, by no more than about ±30%, by no more than about ±25%, by no more than about ±20%, by no more than about ±15%, by no more than about ÷10%, by no more than about ±5%.

In general, the ratio of the average size of a size class to the average size of a successively smaller size class may be about 2:1. In various embodiments, the ratio of the average size of a size class to the average size of a successively smaller size class may be about 2.25:1, about 2.5:1, about 2.75:1, about 3.0:1, about 3.25:1, about 3.5:1, about 3.75:1, about 4:1.

In some embodiments, the first size class comprises one or more components each comprising a material selected from the group consisting of rock and gravel. In some embodiments, the first size class comprises one or more components each comprising a material selected from the group consisting of gravel and sand. In some embodiments, the second size class comprises one or more components each comprising a material selected from the group consisting of rock and gravel. In some embodiments, the second size class comprises one or more components each comprising a material selected from the group consisting of metal oxides. In some embodiments, the third size class comprises one or more components each comprising a material selected from the group consisting of rock, gravel, sand, and silt. In some embodiments, the fourth size class comprises one or more components each comprising a material selected from the group consisting of sand and silt. In some embodiments, the fourth size class comprises one or more components each comprising a material selected from the group consisting of soil or a soil material (e.g. gravel, sand, clay, silt, and/or organic material). In some embodiments, the fifth size class comprises one or more components each comprising a material selected from the group consisting of sand and silt. In some embodiments, the fifth size class comprises one or more components each comprising a material selected from the group consisting of soil or a soil material (e.g. gravel, sand, clay, silt, and/or organic material). In some embodiments, the storage medium comprises a mixture of quartzite (rock, gravel and/or sand), and topsoil (either washed or unwashed) and/or subsoil (either washed or unwashed). In some embodiments, only 3 or 4 size classes are present.

In some embodiments, the granular medium comprises first and second size classes, and further mixed with one or more of: sand, silt, soil, organic material, metals, metal oxides, silicates, metal carbonates, graphite, and metal nitrates, wherein the sand, silt, soil, organic material, metals, metal oxides, silicates, metal carbonates, graphite, metal nitrates have particle sizes of less than about 1 mm. In some embodiments, the granular medium comprises first, second, and third size classes, further mixed with one or more of: sand, silt, soil, organic material, metals, metal oxides, silicates, metal carbonates, graphite, and metal nitrates, wherein the sand, silt, soil, organic material, metals, metal oxides, silicates, metal carbonates, graphite, metal nitrates have particle sizes of less than about 1 mm.

In some embodiments, the average size of the first size class is about 50 mm or less. In some embodiments, the average size of the first size class is about 20 mm to about 40 mm. In some embodiments, the average size of the first size class is about 16 mm to about 40 mm. In some embodiments, the average size of the first size class is about 10 mm to about 40 mm. In some embodiments, the average size of the second size class is about 4 mm to about 12 mm. In some embodiments, the average size of the second size class is about 0.060 mm to about 2 mm. In some embodiments, the average size of the second size class is about 2 mm to about 4 mm. In some embodiments, the average size of the third size class is about 1 mm to about 3 mm. In some embodiments, the average size of the third size class is about 0.7 mm to about 2 mm. In some embodiments, the average size of the third size class is about 0.250 mm. In some embodiments, the average size of the fourth size class is about 0.3 mm to about 0.8 mm. In some embodiments, the average size of the fourth size class is about 0.2 mm to about 0.6 mm. In some embodiments, the average size of the fourth size class is about 0.032 mm. In some embodiments, the average size of the fifth size class is about 0.05 mm to about 0.15 mm. In some embodiments, the average size of the fifth size class is about 0.04 mm to about 0.12 mm. In some embodiments, the average size of the fifth size class is about 0.025 mm to about 0.15 mm. In some embodiments, the average size of the fifth size class is about 0.004 mm.

In some embodiments, the first size class comprises about 20% to about 70% by volume of the total medium. In some embodiments, the first size class comprises about 35% to about 65% by volume of the total medium. In some embodiments, the first size class comprises about 45% to about 60% by volume of the total medium. In some embodiments, the first size class comprises at least about 20% by volume of the total medium. In some embodiments, the first size class comprises at least about 35% by volume of the total medium. In some embodiments, the first size class comprises at least about 45% by volume of the total medium. In some embodiments, the second size class comprises about 1% to about 80% by volume of the total thermal energy storage medium. In some embodiments, the second size class comprises about 2% to about 30% by volume of the total medium. In some embodiments, the second size class comprises about 10% to about 15% by volume of the total medium. In some embodiments, the second size class comprises at least about 1% by volume of the total medium. In some embodiments, the second size class comprises at least about 2% by volume of the total medium. In some embodiments, the second size class comprises at least about 10% by volume of the total medium. In some embodiments, the third size class, when present, comprises about 1% to about 20% by volume of the total medium. In some embodiments, the third size class, when present, comprises about 5% to about 15% by volume of the total medium. In some embodiments, the third size class, when present, comprises about 5% to about 10% by volume of the total medium. In some embodiments, the third size class, when present, comprises at least about 1% by volume of the total medium. In some embodiments, the third size class, when present, comprises at least about 5% by volume of the total medium. In some embodiments, the third size class, when present, comprises at least about 7% by volume of the total medium. In some embodiments, the fourth size class, when present, comprises about 1% to about 10% by volume of the total medium. In some embodiments, the fourth size class, when present, comprises about 1% to about 5% by volume of the total medium. In some embodiments, the fourth size class, when present, comprises about 1% to about 3% by volume of the total medium. In some embodiments, the fourth size class, when present, comprises at least about 2% by volume of the total medium. In some embodiments, the fourth size class, when present, comprises at least about 4% by volume of the total medium. In some embodiments, the fourth size class, when present, comprises at least about 10% by volume of the total medium. In some embodiments, the fifth size class, when present, comprises about 0.2% to about 2% by volume of the total medium. In some embodiments, the fifth size class, when present, comprises about 0.4% to about 1.5% by volume of the total medium. In some embodiments, the fifth size class, when present, comprises about 0.6% to about 1.4% by volume of the total medium.

Soluble minerals and/or liquid materials may in some embodiments be used to fill in the remaining void spaces in the mixture. Since particles of about 20 microns or less may be a respiratory hazard, preferred particles of this size used in the invention may in some embodiments be of a soluble mineral that can dissolve in body fluids, and may be naturally present in the human body. In some embodiments, the soluble mineral is a mineral that does not pose an inhalation risk (e.g. fine particles of sodium silicates or potassium silicates). In some embodiments, the soluble minerals meet European workplace safety standards. Non-limiting examples of soluble minerals include soluble carbonates, oxides, and nitrates, including Na₂CO₃, K₂CO₃, KNO₃, Ca(NO₃)₂, NaNO₃ and NaNO₂. In some embodiments, the soluble mineral is Na₂CO₃. While chlorides may be used, such as NaCl, they are not ideally suited to use with metal conduits, as they may cause rusting of the metal conduits. However, NaCl may be more suitable for use in combination with conduits that are non-corrosive to chlorine. The soluble minerals may also include low melting salts (molten salts), such as NaNO₃ and NaNO₂ which melt below 200° C., and which function as a liquid upon melting. In some embodiments, the soluble mineral is NaNO₃. In some embodiments, the soluble mineral is NaNO₂. Liquid materials which may be used include, for example, silicone oil, mineral oil, glycerol, sugar alcohols, retene, and/or tetracosane. In some embodiments, the storage medium does not comprise a soluble mineral. In some embodiments, the storage medium does not comprise a liquid.

In some embodiments, the one or more soluble minerals, when present, comprise about 0.1% to about 5% by volume of the total medium. In some embodiments, the one or more soluble minerals comprise about 0.1% to about 1% by volume of the total medium. In some embodiments, the one or more soluble minerals comprise about 0.2% to about 0.7% by volume of the total medium. In some embodiments, the one or more soluble minerals comprise at least about 0.2% by volume of the total medium. In some embodiments, the one or more soluble minerals comprise at least about 0.4% by volume of the total medium. In some embodiments, the one or more soluble minerals comprise at least about 0.8% by volume of the total medium.

In some embodiments, the thermal energy storage medium is selected at least in part from locally available materials, thus saving on transportation costs. In some embodiments, the thermal energy storage medium is selected entirely from locally available materials. In various embodiments, “locally available” indicates materials available within about 500 km, within about 400 km, within about 300 km, within about 200 km, within about 100 km, within about 50 km from the site of the thermal energy storage system. The materials may be available in final form, or may be processed from raw materials available locally into their final form. For example, locally available rock may be used without further processing, or alternatively, may be crushed and separated according to size to produce particles of rock of the desired size. Locally available soil can come from the immediate site if the storage system is placed at least partially below ground and the excavated material is used. Material excavated for other purposes on the site may also be recycled for this purpose.

### Exemplary Embodiments of Thermal Energy Storage Mediums

Non-limiting examples of thermal energy storage mediums include the following (showing volumetric percent of the total medium):

| | | | | 4^{th} size class | |
|---|---|---|---|---|---|
| | | | | 0.1-1.0 mm | |
| | | | | (e.g. sand, metal | |
| | 1^{st} size class | 2^{nd} size class | 3^{rd} size class | carbonate, metal | Soluble |
| | 20-40 mm | 3-10 mm | 1-2 mm | oxide, and/or | mineral |
| | (e.g. gravel) | (e.g. gravel) | (e.g. sand) | metal nitrate) | 0.001-0.020 mm |
| Medium 1 | 70% | 20% | 7% | 2% | 1% |
| Medium 2 | 70% | 15% | 10% | 3% | 2% |
| Medium 3 | 70% | 9% | 15% | 2% | 4% |
| Medium 4 | 75% | 10% | 10% | 1% | 4% |
| Medium 5 | 85% | 15% | — | — | — |
| Medium 6 | 50% | 18% | 15% | 15% | 2% |
| Medium 7 | 60% | 22% | 10% | 3% | 5% |
| Medium 8 | 65% | 15% | 15% | 2% | 3% |
| Medium 9 | 70% | 5% | 20% | 1% | 4% |
| Medium 10 | 70% | 30% | — | — | — |
| | | 2^{nd} size class | | | |
| | 1^{st} size class | 2 mm | 3^{rd} size class | 4^{th} size class | 5^{th} size class |
| | 16 mm | (e.g. gravel | 0.25 mm | 0.032 mm | 0.004 mm |
| | (e.g. gravel) | and/or sand) | (e.g. sand) | (e.g. silt) | (e.g. silt) |
| Medium 11 | 70% | 20% | 7% | 2.3% | 0.7% |

Optionally, in Mediums 1-10, another size class of about 0.008 mm in size may substitute for a portion of one or more of the other size classes or soluble minerals to comprise about 0.2% to about 0.4% of the above medium.
Conduit and Fluid Channelling Device Arrangement

Generally, the conduit material, shape, diameter, spacing, packing arrangement, and angle within the thermal energy storage medium may vary depending on the thermal energy storage medium used, the total amount of energy to be stored, the required response time of the system, etc. In general, it is preferred that the particular conduits and arrangement of the thermal energy storage system meet local, state, and/or federal requirements (e.g. boiler code).

The conduits disposed within the thermal energy storage system may be configured in any suitable manner. The conduits may be arranged vertically, horizontally, at an angle, or at a combination of such angles. In some embodiments, the conduits are substantially horizontal. In some embodiments, the conduits are substantially vertical. In some embodiments, the conduits are parallel to each other. The conduits may be arranged at an angle in order to balance the effects of corrosion and impurity deposits within the conduits from the working fluid. For example, when the working fluid is water/steam, water running within the conduits causes corrosion; increased water speeds increase corrosion. On the other hand, slower moving water increases deposits of impurities in the water within the conduits. In some embodiments, the conduits are inclined at an angle such that when liquid fluid is contained within the conduits, the liquid runs downhill within the conduits at a speed of about 1.5 to about 2.5 m/s, for example about 2.0 m/s. In some embodiments, the conduits are inclined at an angle of about 1 to about 15 degrees. In some embodiments, the conduits are inclined at an angle of about 2 to about 4 degrees.

Conduit spacing may be selected based on the distance from which heat can be extracted from that particular medium over a particular desired length of time. The spacing of the conduits relative to each other within the storage system may vary according to the particular storage medium used, the type of conduit, etc. In general, closer spacing of conduits may be used when faster response from the storage system is required (e.g. for transient peak demands). In general, spacing the conduits further apart will allow for greater total energy storage, and may be used when slower response of the storage system is acceptable. Additionally, the conduits spacing may reflect the physical characteristics of the medium. For storage mediums having higher conductivity, the conduits may be spaced relatively further apart. In various embodiments, the conduit spacing is chosen to achieve energy recovery efficiency of greater than about 80%, greater than about 85%, greater than about 90%, greater than about 95% from the storage medium.

Conduits of any suitable diameter or closed cross-sectional shape may be used, and further may be made out of any material suitable for transferring heat from the working fluid to the medium and vice versa. The conduits, for example, may be metal, a polymeric material, silicon carbide, fused zirconia or other very high strength ceramics. Non-limiting examples of metal conduits include those comprising carbon steel, low carbon steel, stainless steel, black iron, carbon-manganese steel, mild steel, and low alloy steels containing nickel chromium, molybdenum, vanadium, copper, niobium, or titanium. In some embodiments, the conduits comprise low carbon steel. In some embodiments, the conduits are ASTM A106 Grade B seamless steel pipes. In some embodiments, the conduits are corrosion resistant with regards to the storage medium.

As illustrated in FIG. 9, the conduits 34 may in some embodiments comprise thermally conductive heat transfer elements 36, which have a thermal conductivity k₂ greater than the average thermal conductivity of the discrete components of the storage medium, and which are located in heat exchange relationship with the conduits 34. Each of the heat transfer elements 36 functions alternatingly as a heat distributor and retriever and it extends horizontally into the medium 35 for the purpose of transferring thermal energy reversibly between the working fluid in the associated conduit 34 and the discrete (thermally conductive) components of the medium. In general, the thermally conductive heat transfer elements may have a thermal conductivity within the range of about 40-2000 W/m·K. In various embodiments, the thermally conductive heat transfer elements may have a thermal conductivity within the range of about 100-400 W/m·K, more than about 150 W/m·K.

The heat transfer (distributor/retriever) elements 36 may be composed of a carbon-based material or any other heat resistant material that has a high thermal conductivity relative to the medium components. In some embodiments, the heat transfer element comprises the same material as the conduits. In some embodiments, the heat transfer element is formed from a metal such as aluminium. In some embodiments, they may be shaped as shown in FIG. 8, or, in other embodiments, be formed as substantially flat sheets to overlie each of the conduits along at least a major portion of the lengths of the conduits within the storage system, as indicated in FIG. 9.

In some embodiments, some or all of the conduits may be replaced with fluid channelling devices, comprising first and second spaced-apart conduit portions and a plurality of linking conduits extending between and interconnecting the first and second conduit portions in fluid passage communication, wherein at least some of the linking conduits have longitudinally spaced protuberant regions. While the fluid channeling devices have been developed in relation to a thermal energy storage system it is to be understood that the fluid channelling device per se does have broader application, for example, in the channeling of various fluids (i.e. liquids of gases) under various temperatures. The longitudinally spaced protuberant regions of the linking conduits of the fluid channelling device may have any bulging (i.e., generally convex or generally bulbar) form, for example such as one composed of two conjoined frusto-conical portions. However, in one embodiment of the invention the longitudinally spaced protuberant regions have a generally spherical form. Without wishing to be bound by theory, the protuberant and, in particular, generally spherical form may provide optimal performance in a thermal energy storage system under potentially conflicting requirements for maximised surface area for heat exchange contact with surrounding material, minimum internal pressure-induced stress and minimal material cost as dictated by wall thickness. Each of the protuberances may have a diameter of the order of, for example, about 200 mm to about 300 mm and have a centre-to-centre spacing of, for example, about 300 to about 400 mm. The fluid channelling device may optionally be formed from various materials, depending upon the nature of the working fluid and operating conditions. In some embodiments, it comprises mild steel or an alloy steel.

FIG. 11 illustrates one embodiment of the channelling devices 46, comprising first and second (upper and lower) spaced-apart conduit portions 47 and 48 which will often, but not necessarily, extend parallel to one another and be positioned in the medium with a generally horizontal disposition. The working fluid from the heating system 10/20 may be admitted to the lower conduit portion and directed to the turbine 11 from the upper conduit portion, although other configurations may be used. A plurality of linking conduits 49 may extend vertically between and interconnect the two conduit portions 47 and 48. The linking conduits 49 associated with each pair of horizontally disposed conduit portions may be arranged in a single row or, as illustrated, in multiple parallel rows and at least one, and in some embodiments multiple or all, of the linking conduits are formed or provided with hollow protuberant regions 50 which, as illustrated in FIG. 12, have a generally spherical form. However, they might have any other generally bulbous or convex shape. The component parts of the channelling devices (especially the protuberant portions 50 of the linking conduits) may be positioned in heat exchange relationship with the medium 45. Optionally, the composite structure is surrounded by a layer of insulating material 51. The upper and lower conduit portions of each channelling device will in some embodiments have a length of 12 m and may be spaced apart by a distance of 8 m to 12 m. Depending upon the storage capacity required of the system, a complete storage module might be constructed with a volume of, for example, about 5×10³ m³.

In some embodiments, the conduits comprise pipes. In general, the pipes may have a diameter of about 0.25″ to about 16″. Pipe diameters listed herein indicate the nominal inside diameter of the pipe. In some embodiments, the diameter of the pipes is about 0.25″ to about 4″. In some embodiments, the diameter of the pipes is about 0.5″ to about 2.0″. In some embodiments, the diameter of the pipes is about 1″ or less. In some embodiments, the diameter of the pipes is about 0.75″ or less. In some embodiments, the diameter of the pipes is about 0.5″ or less. In some embodiments, the diameter of the pipes is about 0.5″. In some embodiments, the diameter of the pipes is at least about 0.5″. In some embodiments, the thickness of the pipe walls is about 1 to about 16 mm, for example about 1 to about 3 mm. In some embodiments, the thickness of the pipe walls is about 2.1 mm. In some embodiments, the thickness of the pipe walls is at least about 0.75 mm. In some embodiments, the pipes are Schedule 5 pipes. In some embodiments, the pipes are Schedule 10 pipes. Generally, smaller diameter pipes are more effective at transfer of heat between the working fluid and the thermal storage medium, due to their greater surface area. However, the lower limit of effective pipe size may be controlled by corrosion limits.

The conduits may, for example, be arranged as a single (vertical or horizontal) layer of conduits, or may arranged as an array of multiple layers (e.g. 2, 3, 4, 5, 10, 20, or more) of conduits. Additionally, multiple arrays of conduits may be present within a plant, and may be in fluid communication with each other or may be isolated from one another. In some embodiments, the conduits are arranged in a square or rectangular pattern within an array. Various layers of conduits may be disposed within different thermal energy storage mediums and/or may be configured such that all layers are not in fluid communication with each other. By operating various layers or groups of layers within an array separately, more even distribution of working fluid may be achieved, maximizing heat transfer and spreading the wear on the conduits more evenly. Additionally, in the case of horizontal layers of conduits, operating layers or groups of layers within an array separately may reduce parasitic loss of energy by avoiding having to pump working fluid to the full height of the array. In some embodiments, layers with a height up to about 3 m are in fluid communication with one another. In one example, various layers may be linked to receiver elements of varying distances from the thermal energy storage system. In another example, layers at a particular height may be linked to other layers at that same height in one or more additional conduit arrays. Additionally, various layers of conduits and their surrounding storage medium may be isolated from each other by isolation barriers. Isolation barriers may be used, for example, to thermally isolate various layers of conduits from each other. In another example, horizontal structural isolation barriers may be used to structurally isolate various layers of conduits, in order to prevent a large pressure differential within the storage medium between the top and bottom layers of conduits, and avoid increased stress on the lower level conduits. Isolation barriers may also be used to maintain physical separation between different storage mediums.

The following description of an array of conduits assumes that the length of the conduit corresponds to the depth of an array, the length of the layer of conduits corresponds to the width of the array, and the length of the multiple layers corresponds to the height of the array. However, it is to be understood that these may correspond to different dimensions in space relative to whether the conduits are oriented in a vertical or horizontal direction, and whether the conduit layers are oriented in a vertical or horizontal direction. A layer of conduits may be any suitable width (e.g. about 1 to about 12 meters), comprise any suitable number of conduits (e.g. about 2 to about 20), and have conduits of any suitable length (e.g. about 3 to about 600 meters). In some embodiments, a conduit layer comprises about 15-25 conduits, for example about 18 conduits. In some embodiments, the width of a layer of conduits may comprise, for example, about 1 to about 3 meters, for example, about 1.2 to about 2.3 meters. In some embodiments, the length of the conduits is about 10 to about 12 meters, for example about 11.5 meters. An array of conduits may comprise any suitable number of layers (e.g. about 2 to about 60), in any suitable height, (e.g. about 0.5 to about 12 meters). In some embodiments, the array of conduits comprises about 40 to about 100 layers of conduits, for example about 45 layers. In some embodiments, the height of the array of conduits is about 3 to about 6 meters, for example about 4 meters.

Any suitable header arrangement for the conduits may be used. The conduits may run, for example, in series, parallel, or sequential use of parallel flow, or in a combination of these. Both ends of the conduits may be attached to headers. In some embodiments, only one end of at least one of the conduits is not attached to a header (i.e. a one-end conduit). Additionally, one or more or all of the conduits may comprise end fittings (e.g. threaded plugs, offset orifices, concentric grooves) at one end of the conduit, wherein the end fittings evenly distribute fluid flow between the conduit, to evenly distribute and so maximize thermal energy storage and extraction. The end fittings may be at the inlet or outlet end of the conduits. The flow of working fluid may be input into and/or output from the storage system at a single or multiple locations within the storage system, and the inlet and outlet may be the same or separate. In some embodiments, the heated working fluid (e.g. steam) is added to the top layer of an array of horizontal conduit layers, such that the cooled working fluid (e.g. water) may exit the storage system at the bottom of the array of conduits, unimpeded by additional incoming heated working fluid. In some embodiments, the conduits may be linked with serpentine headers. Without wishing to be bound by theory, serpentine headers may allow for expansion of the conduit arrangement upon thermal expansion, thus causing less stress on the conduits. In some embodiments, the headers can expand up to about 20 mm in a vertical direction upon thermal expansion. Additionally, the headers may contain pivoting plates that pivot into a vertical position upon adding the medium to an array of conduit layers, such that the plates help to constrain the medium in place. As the plates are not connected to each other they may help to constrain the medium yet still allow for expansion of the storage system upon heating. In some embodiments, the header structure may comprise a header structure as described in U.S. patent application Ser. Nos. 12/012,920; 12/012,829; or 12/012,821, all filed Feb. 5, 2008, the disclosures of which are herein incorporated by reference in their entirety.

To replace a conduit, the old conduit may be cut from both headers at both ends, and the replacement conduit butt welded to the old conduit. The old conduit and the attached replacement conduit are pulled through the storage medium until the new conduit occupies the prior location of the old conduit, after which the old conduit is removed. The replacement conduit may either be welded onto the old conduit in its entirety, or the replacement conduit may be welded onto the old conduit in successive sections (e.g. 3-4 m sections). The new conduit may then optionally be welded to both headers. While the conduits may be welded to the headers, in some embodiments, the conduits are not welded to the headers, to allow for easier replacement of old or failing conduits, or for periodic removal of conduits to test for wear.

Layers of conduits attached to header portions may be made in modular form, for easy shipment. The header portions may be welded to each other (e.g. manually or through an automated robotic manufacture) on site to form the array of conduits, either by directly welding the header portions to each other (e.g. when each header portion forms a section of a serpentine header), or by welding a linking header portion to either side of a header (e.g. welding a c-shaped section between straight header portions). In some embodiments, a stack of layers attached to header portions may be linked to each other, e.g. by chains. In this embodiment, the stack may be shipped in a collapsed form for easier transport, and once on site, may be stretched to its full height and the array of conduits produced by welding the header portions together. The modular arrangement advantageously permits an entire stack of conduit layers to be collapsed, wherein the collapsed stack may fit in a standard shipping container, thus minimizing the costs of transport. In some embodiments, when the stack is flattened for transport, it is about 2.5 m in height.

### Configuration of Thermal Energy Storage System

The storage system may be above ground, below ground, or partially above and partially below ground level. In some embodiments, the storage system is placed below or partially below ground, by constructing a pit for the storage system, wherein at least some of the material(s) removed from the ground in constructing the pit are used as a material in the storage medium. In some embodiments, a roof or roofed structure is placed above ground, and one or more tunnels may be constructed underneath the roof, in order to facilitate maintenance and operations of the facility, for example, permitting checking of fluid levels, pressure, and pumps. The medium within the storage system may be constrained by structures such as e.g. concrete retaining walls, steel retaining walls, tension elements passing through the system, and/or a large pile of additional storage medium. In some embodiments, “bookend” type steel structures, in which a portion of the structure is under the storage system and a portion abuts the side of the system, may be used to constrain the medium. In this type of structure, the bookend structure is able to slide and move away from the storage system when the storage system expands upon heating, thus releasing stress on the conduits. When placed below or partially below ground, the surrounding earth may be used, for example, to constrain the medium within the system. Often the walls of the earth trench will be angled outward according to local construction regulations, to assure containment. In some embodiments, earth and/or sand may be placed alongside and/or atop the storage unit as thermal insulation. Various structural supports may be used to support the conduit, layer of conduits, or array of conduits. In some embodiments, the medium itself may also provide the support for the conduit, layer of conduits, or array of conduits.

Multiple arrays of conduits may be present in a thermal energy power or steam plant. These multiple arrays may be in fluid communication with each other or may be isolated from each other, may be located adjacent to each other or be separated, may be disposed within the same or different thermal energy storage mediums, and further may optionally be separated from other arrays by an isolation barrier. In some embodiments, multiple arrays are modular, permitting individual arrays to be taken off line, for e.g. maintenance, while the remainder remain operational. In some embodiments, multiple arrays may be placed side by side to make a row (e.g. with the row being perpendicular to the length of the conduits). In some embodiments, 2 or more rows may be placed adjacent to each other to form a “shed”. Arranging multiple arrays into rows or sheds may reduce costs of constructing support structures to contain the storage medium(s). Arranging a single array or adjacent multiple arrays in such a way as to minimize surface area of the thermal energy storage system may reduce heat loss from the storage system. Accordingly, in some embodiments, the thermal energy storage system is cuboid in shape. While the cuboid may be of any suitable dimensions, in some embodiments, it is about 12 meters×about 12 meters×about 4 meters high, about 12 meters×about 12 meters×about 12 meters high.

The thermal energy storage system may be sited at any convenient circuit location between the heating system and the turbine but it optionally is positioned to extend around at least a portion of the periphery of the heating system.

The thermal energy storage system may be constructed, for example, by addition of storage medium to a pre-constructed conduit layer or array. In another example, the storage system can be constructed step-wise by alternately layering conduits or conduit layers with thermal energy storage medium. When adding storage medium to a pre-constructed conduit layer or array, various support elements (e.g. cross-braces, spacers, etc.) may be used to support the layer or array in its proper position during addition of storage medium. Temporary ducts may be used to direct the medium to the bottom of the layer or array, and additionally to help prevent segregation of variously sized materials during addition of storage medium or damage to the conduits. In general, smoother materials may pour more easily into the layer or array without separation. The storage medium may, in some cases, be piled into the layer or array as high as possible, in order to utilize pressure from the medium to minimize voids in the storage medium. With use over time, small movements of the storage medium resulting from thermal expansion and contraction may result in a settling and tighter packing of the medium, thus increasing thermal contact and thus effective thermal conductivity. In some embodiments, the piled medium above the array may enter the array through a shaped opening that prevents reversed flow of the medium.

The following is an example of one method for constraining the medium and reducing movement between the medium and the conduits. Triaxial constraint (constraining the storage medium on all six faces of a cuboid containment) may be used to constrain the medium. The method completely eliminates relative movement between the medium and all other parts, conduits, containment and structures that support the conduits. To achieve this, the storage medium is added to, for example, a steel “box” until it is completely full. The openings in the box through which it is filled can be closed, after filling, or they can be shaped to prevent the medium from coming back out. Shaping the inlets to prevent reverse flow, can provide some “topping up” of the medium after compaction. If the coefficient of thermal expansion (CTE) of the storage medium is greater than the CTE of the steel containment, the medium will pack tighter and tighter as the system heats up. When first heated the medium will compact. When partly cooled, during discharge, more medium must be added to keep the containment full. This may occur for many cycles of charge and discharge, for example, up to 100 cycles. When this system is cooled for maintenance, the stresses in the structure and conduits will reduce. If the CTE of the storage medium is a smaller value than the CTE of steel containment, the storage medium is packed less and less tightly as the system heats up. When partly cooled for the first time, during discharge, the containment will compact the storage medium. When the peak temperature is reached again, then more of the medium can be added. When this system is cooled, the steel structure and conduits will compress the storage medium to generate the highest stresses in both the steel and the storage medium. In both cases, the CTE match between medium and steel may be managed by medium selection. Also, the stiffness of the storage medium may be limited. These parameters can keep the stresses in the steel structure, conduits, and storage medium within the elastic limit and proven acceptable limits.

### Thermal Energy Storage System Operation

Briefly, in the charging mode, hot pressurized working fluid (e.g. pressurized water and steam) enters the storage system via the conduits, and the heat is transferred from the hot working fluid through the conduit walls, diffusing into the storage medium. In the extraction mode, cool pressurized working fluid (e.g. water) enters the storage system via the same conduits, and heat is transferred by conduction from the storage medium through the conduit walls into the cool working fluid. The working fluid (e.g. water) is flashed to vapor (e.g. steam), which is discharged from the storage system. The working fluid may be circulated by passive circulation and/or by a pump. Optionally, an occasional acoustic vibration or physical impulse may be used to resettle material near the conduits after thermal expansion.

The working fluid may be added to the storage system at various parts of the system. For example, when the conduits are substantially horizontal, hot working fluid may be added to the lowest part of the conduit headers, such that vapor moves up the conduits. Hot working fluid may also be added to the highest part of the conduit headers, such that the vapor moves down through the conduits. When the conduits are at an angle (e.g. 2-4 degrees) from horizontal, this embodiment has the advantage of avoiding interference between the vapor and liquid working fluid, as the condensed and cooled liquid working fluid will run down to the lower parts of the system due to the tilt of the conduits.

Optionally, additional liquid working fluid (e.g. water) is circulated through the conduits at all times, helping to flush sediments out of the conduits. However, circulating too much liquid (e.g. water) such that no vapor (e.g. steam) is generated results in a higher parasitic loss of power. When the working fluid is water, in some embodiments, about 1.1 times as much water is recirculated as the rate at which steam is generated. Thus, in this embodiment, 90% of the water is made into steam, resulting in a ratio of 9:1 steam:water.

While operating temperatures may vary according to the particular storage medium, conduit configuration, particular working fluid, etc., in general storage system operating temperatures may range from about 100° C. to about 1200° C. In various embodiments, the storage system operating temperatures about 100° C. to about 365° C., about 100° C. to about 374° C., about 100° C. to about 500° C., about 100° C. to about 500° C., about 120° C. to about 365° C., about 180° C. to about 280° C., about 220° C. to about 280° C., greater than about 100° C., less than about 365° C. When the working fluid is water, the storage system operating temperatures may range from about 120° C. to about 410° C., for example above about 150° C. In some embodiments, the maximum temperature difference during operation is about 370° C. In some embodiments, the maximum temperature difference during operation is about 59-60° C.

While operating pressures within the conduits may vary according to the particular storage medium, conduit configuration, particular working fluid, etc., in general operating pressures within the conduits range from about 1000 kPa to about 20000 kPa. In various embodiments, the operating pressures range from about 1000 kPa to about 15000 kPa, about 2000 kPa to about 10000 kPa, about 2500 kPa to about 10000 kPa, about 3500 kPa to about 6500 kPa.

In some embodiments, the thermal energy storage system is useful for storing at least about 50 kWh of thermal energy. In some embodiments, the thermal energy storage system is useful for storing at least about 20,000 kWh of thermal energy. In some embodiments, the thermal energy storage system is useful for storing at least about 600,000 kWh of thermal energy. In some embodiments, the thermal energy storage system is useful for storing at least about 16,000,000 kWh of thermal energy.

### Exemplary Storage System Arrangement and Operation

In one non-limiting illustrated embodiment, a stack of steel structures provide “trays” of medium between about 0.3 and about 0.9 metres (one to three feet) deep, each having several layers of conduits. The shallow depth allows the storage medium to move relative to the conduits, and space above the storage medium in each tray allows for expansion and contraction.

The trays are stacked about three metres (ten feet) high. Trays near the top and bottom and at the end of a collection of stacks are operated separately from the middle trays, and the top and bottom trays are insulated from the middle layers and also from each other. Steam is sent only to the middle layer and the condensate, together with some steam, is transferred to the top and bottom lawyers and trays at the end of collections of stacks. Condensate from the steam that charges the middle layers will pass through the other layers to reduce its temperature before returning to the feed heating system, reducing the total cost of insulation and total thermal losses. The reduced temperature condensate will return to the optional deaerator tank. The extra thermal energy it contains will reduce the amount of turbine bleed steam to heat the deaerator. An optional pressure energy recovery engine or a two stage feed pump may be used to recover most of the pressure energy of the condensate. A mixing nozzle may be used to ensure that thermal energy is not lost by the condensate flashing to steam. This allows for a higher temperature of return condensate to accommodate simpler controls.

This example utilizes moisture separation and one stage of reheating of the partly expanded steam, although superheated steam operation (including at least one reheating stage) may also be used. The reheating can be integrated with the thermal energy storage system, for example, by extra layers of conduits, which may have thinner walls due to the lower pressure. As an alternative to the use of reheaters are cylindrical pressure vessels that condense steam and heat lower pressure steam to superheat it.

Feed water is heated by the turbine bleed-steam, and the water is separated from the steam. The feed heater output temperature may be in the range of, for example, about 120° C. to about 180° C. The feed heating system is closely coupled with the turbine and advantageously provides reasonable efficiency for a saturated steam turbine system.

During discharge of the thermal energy storage system the feed water entering will be heated more, nearly to saturation temperature, in lower temperature sections (an economizer) of the thermal energy storage system. This heating will raise the water temperature to within about 15° C. of the saturation temperature. The temperature of water entering the evaporation sections will be in the range of, for example, about 205° C. to about 295° C.

The lower temperature structure (e.g. the upper and lower trays) of the thermal energy storage system can be in contact with the higher temperature structure but movement or flexibility at the interface is preferred to limit thermal stresses. These sections will be charged/heated by the condensate from the higher temperature sections. They may gain a small amount of heat from the adjacent high temperature sections. The movement of heat between trays at different temperatures can be kept, for example, at less than about 2% of stored energy per day with practical design arrangements. This energy is not energy lost, but rather it shifts slowly and requires a slow start after a pause of several days between daily cycling of the thermal energy storage system. Energy loss from the system can practically be kept to less than, for example, about 1% of the average energy stored per day.

In this illustrative example, only the trays near the center of the stack will evaporate steam. The feed water heating, in the top and bottom trays, is desirable as it makes use of the lower temperature stored energy from the condensed charging steam, and also minimizes thermal stresses and shock for all stages of the energy recovery. In some embodiments, three or four stages of heating may be used.

At peak pressure discharge (for modest thermal energy storage system output as the solar input reduces) the feed water will be at, for example, about 180° C. and heated in the thermal energy storage system to as much as, for example, about 305° C. before entering the evaporator “trays” heated to, for example, about 310° C. or higher. The steam may then be heated in a superheater section of thermal storage to 400° C. or higher. This operating mode supports stable operation of the turbine during cloud passing and when the late afternoon output does not meet the full load turbine requirement. After a short time, the system may ramp down the turbine output to a reduced output, for example about 75% of electrical output. The thermal energy storage system, with some continuing solar input, will be able operate the turbine at constant output for some hours as determined by the thermal energy storage system design specification.

### EXAMPLE

The conductivity of topsoil from Carrizo Plains was measured. The soil was alluvium formed from quartzite, basalt and shale. At low temperature (approx 50° C.) the surface soil conductivity was 0.34 W/(m·K). Surprisingly, the conductivity at 250° C. was greater, 0.49 W/(m·K).

A mixture of 21% Carrizo Plains topsoil plus 79% quartzite rounded pebbles of nominal size 38 mm (one and a half inch) resulted in a conductivity of 0.78 W/(m·K) at 250° C.

Variations and modifications may be made in respect of the power plant and energy storage system as above described without departing from the scope of the invention as described and as defined in the following claims.

What is claimed is:

1. A thermal energy storage system comprising:
(a) a granular thermal energy storage medium comprising at least a first size class of granules and a second size class of granules;
wherein each size class of granules comprises one or more components;
wherein the individual granules of each size class deviate from the average granular size for that size class by no more than about ±50%;
wherein first size class is the largest size class;
wherein the ratio of the average size of the first size class to the average size of the second size class is at least about 2:1; and
(b) one or more conduits disposed within the medium, and arranged to receive a source of thermal energy.

2. The thermal energy storage system of claim 1, wherein each component comprises a material individually selected from the group consisting of: aggregate, glass, sand, and silt.

3. The thermal energy storage system of claim 2, wherein the aggregate is rock or gravel.

4. The thermal energy storage system of claim 3, wherein the rock is crushed rock.

5. The thermal energy storage system of claim 3, wherein the rock is monolithic rock.

6. The thermal energy storage system of claim 3, wherein the rock is quartzite.

7. The thermal energy storage system of any one of claims 1-6, wherein the ratio of the average size of the first size class to the average size of the second size class is at least about 3:1.

8. The thermal energy storage system of any one of claims 1-6, wherein the ratio of the average size of the first size class to the average size of the second size class is at least about 4:1.

9. The thermal energy storage system of any one of claims 1-8, wherein the average size of the first size class is about 50 mm or less.

10. The thermal energy storage system of any one of claims 1-8, wherein the average size of the first size class is about 16 mm to about 40 mm.

11. The thermal energy storage system of any one of claims 1-10, wherein the one or more components of the first size class each comprise a material independently selected from the group consisting of rock and gravel.

12. The thermal energy storage system of any one of claims 1-11, wherein the average size of the second size class is about 4 mm to about 12 mm.

13. The thermal energy storage system of any one of claims 1-12, wherein the one or more components of the second size class each comprise a material independently selected from the group consisting of rock and gravel.

14. The thermal energy storage system of any one of claims 1-13, wherein the thermal energy storage medium comprises a third size class.

15. The thermal energy storage medium of claim 14, wherein the ratio of the average size of the second size class to the average size of the third size class is at least about 2:1.

16. The thermal energy storage system of any one of claims 14-15, wherein the one or more components of the third size class each comprise a material independently selected from the group consisting of rock, gravel, glass, sand, and silt.

17. The thermal energy storage system of any one of claims 14-16, wherein the average size of the third size class is about 1 mm to about 3 mm.

18. The thermal energy storage system of any one of claims 14-17, wherein the thermal energy storage medium comprises a fourth size class.

19. The thermal energy storage medium of claim 18, wherein the ratio of the average size of the third size class to the average size of the fourth size class is at least about 2:1.

20. The thermal energy storage system of claim 18-19, wherein the average size of the fourth size class is about 0.3 mm to about 0.8 mm.

21. The thermal energy storage system of any one of claims 18-20, wherein the thermal energy storage medium comprises a fifth size class.

22. The thermal energy storage medium of claim 21, wherein the ratio of the average size of the fourth size class to the average size of the fifth size class is at least about 2:1.

23. The thermal energy storage system of any one of claims 21-22, wherein the average size of the fifth size class is about 0.05 mm to about 0.15 mm.

24. The thermal energy storage system of claim 1, comprising up to 5 size classes, wherein the ratio of the average size of each successively smaller size class to the average size of the preceding size class is no more than about 1:2.

25. The thermal energy storage system of any one of claims 1-24, wherein the thermal energy storage medium comprises one or more soluble minerals.

26. The thermal energy storage system of claim 25, wherein the soluble mineral is a carbonate, an oxide, or a nitrate.

27. The thermal energy storage system of any one of claims 1-26, wherein the first size class comprises about 20% to about 70% by volume of the total thermal energy storage medium.

28. The thermal energy storage system of any one of claims 1-27, wherein the second size class comprises about 1% to about 30% by volume of the total thermal energy storage medium.

29. The thermal energy storage system of any one of claims 14-28, wherein the third size class, when present, comprises about 5% to about 25% by volume of the total thermal energy storage medium.

30. The thermal energy storage system of any one of claims 18-29, wherein the fourth size class, when present, comprises about 2% to about 60% by volume of the total thermal energy storage medium.

31. The thermal energy storage system of any one of claims 21-30, wherein the fifth size class, when present, comprises about 0.2% to about 2% by volume of the total thermal energy storage medium.

32. The thermal energy storage system of any one of claims 25-32, wherein one or more soluble minerals, when present, comprise about 0.1% to about 10% by volume of the total thermal energy storage medium.

33. The thermal energy storage system of any one of claims 1-32, wherein each size class has a thermal conductivity of at least about 0.1 W/m·K at 250° C.

34. The thermal energy storage medium of any one of claims 1-33, wherein the total density of the thermal energy storage medium is at least about 1000 kg/m³.

35. The thermal energy storage system of any one of claims 1-34, wherein the thermal energy storage medium has a void volume fraction of less than about 10%.

36. The thermal energy storage system of any one of claims 1-34, wherein the thermal energy storage medium has a void volume fraction of less than about 5%.

37. The thermal energy storage system of any one of claims 1-36, wherein the source of thermal energy is generated by a solar energy collector system.

38. A method for utilizing stored thermal energy, comprising:
(a) directing a source of thermal energy through the one or more conduits of a thermal energy storage system of any one of claims 1-37, whereby thermal energy transfers from the source of thermal energy into the thermal energy storage medium; and
(b) extracting thermal energy stored in the thermal energy storage medium at a later point in time.

39. The method of claim 38, wherein the source of thermal energy is generated by a solar energy collector system.

40. A thermal power plant comprising:
(a) a turbine;
(b) a heating system for heating a working fluid to be employed as an energy source for the turbine;
(c) a thermal energy storage system of any one of claims 1-37 located in circuit between the heating system and the turbine.

41. The thermal power plant of claim 40, wherein the heating system is a solar energy collector system.

42. A steam plant comprising:
(a) a heating system for heating water, wherein steam is delivered to a outlet; and
(b) a thermal energy storage system of any one of claims 1-37 located in circuit between the heating system and the outlet.

43. The steam plant of claim 42, wherein the heating system is a solar energy collector system.

44. A fluid channelling device comprising first and second spaced-apart conduit portions and a plurality of linking conduits extending between and interconnecting the first and second conduit portions in fluid passage communication, wherein at least some of the linking conduits have longitudinally spaced protuberant regions.

45. A thermal energy storage system comprising:
i) a thermal energy storage medium, and
ii) at least one fluid channelling device as defined in claim 44 disposed within the thermal energy storage medium with the longitudinally spaced protuberant regions in contact with the medium.

46. The thermal energy storage system of claim 45, wherein the thermal energy storage medium comprises an earthen structure composed substantially of conductive inorganic mineral material.

47. The thermal energy storage system of claim 45, wherein the thermal energy storage medium comprises a thermal energy storage medium of any one of claims 1-37.

48. A thermal power plant comprising:
a) a turbine,
b) a heating system for heating a working fluid to be employed as an energy source for the turbine, and
c) a thermal energy storage system located in circuit between the heating system and the turbine,
wherein the thermal energy storage system comprises:
i) a thermal energy storage medium, and
ii) at least one fluid channelling device as defined in claim 44 disposed within the thermal energy storage medium with the longitudinally spaced protuberant regions in contact with the medium, and arranged to receive the working fluid.

49. A thermal energy storage system comprising:
a) a thermal energy storage medium comprising one or more discrete thermally conductive size classes having an average thermal conductivity k₁;
b) one or more conduits disposed within the medium and arranged to carry a working fluid through the medium; and
c) a thermally conductive heat transfer element having a thermal conductivity k₂>k₁ located in heat exchange relationship with at least some of the conduits, the heat transfer element extending through a portion of the medium and being arranged in use to transfer thermal energy reversibly between the working fluid and the medium size classes.

50. A thermal power plant comprising:
a) a turbine;
b) a heating system for heating a working fluid to be employed as an energy source for the turbine; and
c) a thermal energy storage system of claim 49 located in circuit between the heating system and the turbine.
